(19) United States
(12) Patent Application Publication
(10) Pub. No.: US 2019/0295029 A1
(43) Pub. Date: Sep. 26, 2019

(54) MOVABLE FIXED ASSET TRACKING AND WORK ORDER MANAGEMENT SYSTEM

(71) Applicant: Daniel R. Weber, Denver, CO (US)

(72) Inventor: Daniel R. Weber, Denver, CO (US)

(21) Appl. No.: 16/264,129

(22) Filed: Jan. 31, 2019

Related U.S. Application Data
(60) Provisional application No. 62/625,192, filed on Feb. 1, 2018.

(51) Int. Cl. G06Q 10/08; G06Q 10/06

(52) U.S. Cl. CPC G06Q 10/087; G06Q 10/06311

(57) ABSTRACT

Apparatus and associated methods relate to a computer-aided movable fixed asset management system including a host application (host app) and a mobile application (mobile app or driver app), the mobile app granting drivers permission to perform a “next work order step” in a driver workflow, in response to the driver entering information (e.g., movable fixed asset ID, movable fixed asset size) into the mobile app. In an illustrative example, the host app may be resident on a remote server operated by a dispatcher and mobile app may be resident on multiple mobile devices, each operated by a unique driver. Various examples of the computer-aided fixed asset management systems may advantageously maintain an accurate inventory (e.g., ID numbers, counts, locations, sizes) of a fleet of movable fixed assets.

### CROSS-REFERENCE TO RELATED APPLICATIONS

This application claims the benefit of U.S. Provisional Application Ser. No. 62/625,192, titled “Movable Fixed Asset Tracking and Work Order Management System,” filed by Daniel R. Weber, on Feb. 1, 2018.

This application incorporates the entire contents of the foregoing application(s) herein by reference.

### TECHNICAL FIELD

Various embodiments relate generally to tracking fixed asset inventory.

### SUMMARY

Apparatus and associated methods relate to a computer-aided movable fixed asset management system including a host application (host app) and a mobile application (mobile app or driver app), the mobile app granting drivers permission to perform a “next work order step” in a driver workflow, in response to the driver entering information (e.g., movable fixed asset ID, movable fixed asset size) into the mobile app. In an illustrative example, the host app may be resident on a remote server operated by a dispatcher and mobile app may be resident on multiple mobile devices, each operated by a unique driver. Various examples of the computer-aided fixed asset management systems may advantageously maintain an accurate inventory (e.g., ID numbers, counts, locations, sizes) of a fleet of movable fixed assets.

The drivers may operate a fleet of fixed asset moving trucks. The drivers' workflow activities (drop-offs and pick-ups of fixed assets) may be directed by the dispatchers via a link between the host app and the mobile app, for example. The host app may be a web services application that may include at least 3 functional modules: dispatch, work orders and inventory.

The dispatch module may be a web-based application that may present to the dispatcher a graphical user interface displaying a map-based dispatching system. The dispatch module may be operated by the dispatcher and may be operated in a remote location with network access. The dispatcher (or group of dispatchers) may plan the work-flows of the drivers by working with a drag-and-drop map and assignment palette graphical user interface (GUI). As orders come in from customers (e.g., deliver a movable fixed asset, pick up a movable fixed asset) they may appear on the map. The dispatcher may drag and drop the orders from the map into an assignment palette (the drivers' haul list or queue), where the orders may get assigned to specific drivers, and form a workflow. Once published by the dispatcher, the drivers may receive their work-flow via the mobile app, and may perform the tasks necessary to locate, transport and relocate movable fixed assets according to their workflow.

At each pick-up and drop-off site, the drivers may receive the next step of their workflow in response to entering information (e.g., movable fixed asset ID, movable fixed asset size) into the mobile app. The information may be sent to the dispatcher app along with automated information (e.g., time, location, driver ID). As the driver transports the movable fixed asset, the mobile app may send real-time location updates to the dispatcher app. In this manner, the dispatcher app may remain in lock-step with the driver's location and the state of the driver's work-flow. Further, this information entry enforcement may maintain an accurate inventory (e.g., ID numbers, counts, locations, sizes) of a fleet of movable fixed assets.

Via the mobile app, the dispatcher app may provide a map GUI demonstrating where the trucks are, who is driving the trucks, as well as where the movable fixed assets are and what is available. Further, the dispatcher app may determine driver performance times and provide work order history reports to customers. The interactive map GUI within the dispatcher app may be designed as a gaming experience for intuitive interactions with the dispatcher. Movable fixed asset state and movable fixed asset configurations may be depicted as unique puzzle pieces, allowing dispatchers to assemble only compatible work-flow configurations, easing workflow assembly and reducing mistakes.

The inventory module may present to the dispatcher a graphical user interface displaying a map-based and web-based real-time inventory. The real-time inventory counts may be intuitively displayed on the map in clusters with both table and list formats. Because the host app processes the data received from the mobile app to generate an incremental, self-validating inventory, the inventory module may accurately account for all the movements of every movable fixed asset in the system. This accountability enables an accurate real-time inventory of every movable fixed asset in the system.

The dispatcher may select movable fixed assets on the map and may display their logged movements on a history palette. The history palette may reveal the location of a selected movable fixed asset, even if it is in transit on the back of a truck. The inventory module implements a double entry bookkeeping of movable fixed assets. Work orders, movable fixed asset history and movable fixed asset inventory may be imported and exported from the inventory module. The inventory module may provide activity search functionality across custom date ranges. Driver haul times and movable fixed asset age may be exported to various reports, for example, an accounts receivables report for movable fixed assets.

The mobile app (driver app) may be a mobile application in communication with the host app. The host app may synchronize drivers' workflows on the mobile app in real-time. The workflows may include driver clock-in and clock-out as well as activities in-between. The mobile app may provide driving directions for drivers, real-time location updates, recording of weight tickets (pictures), and manifests (e.g., asbestos, meth).

The system may provide an accurate and validated history of movable fixed asset pick-up and drop-off locations with timestamps, which may advantageously be provided to lending institutions to prove “chain-of-title” and/or “chain-of-custody” for a fleet of widely distributed movable fixed assets. The system may also remove field discretion, effectively enforcing submission of movable fixed asset IDs and locations from drivers, for example. Customers may find benefit in being apprised of the locations, and estimated arrival times of movable fixed asset trucks. Drivers may experience reduced frustration as movable fixed assets are largely in the expected locations, and the expected locations are defined in high resolution. Dispatchers may experience higher work efficiency as the drag-and-drop environments ease assembly of work orders and reduce errors. In various embodiments, the movable fixed assets may be containers.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a driver perspective view of a deployment example of an exemplary movable asset tracking system at a worksite, the driver entering an asset number to move to the next step.

FIG. 2 depicts a network diagram of an exemplary movable fixed asset tracking and work order management system.

FIG. 3 depicts a data flow diagram of an exemplary movable fixed asset tracking and work order management system.

FIG. 4 depicts a data flow diagram of a host application of an exemplary movable fixed asset tracking and work order management system.

FIG. 5 depicts a flowchart of an exemplary work order application.

FIG. 6 depicts a flowchart of an exemplary dispatch application.

FIG. 7 depicts a flowchart of an exemplary inventory application.

FIG. 8 depicts a flowchart of an exemplary driver application.

FIG. 9 depicts a flowchart of a work order steps submodule of an exemplary driver application.

FIG. 10 depicts a flowchart of an exemplary asynchronously selectable dispatch menu application.

FIG. 11 depicts a flowchart of an exemplary asynchronously selectable driver menu application.

FIG. 12 depicts an exemplary listing of work order steps associated with work order types.

FIGS. 13A and 13B depict an exemplary work order palette.

FIG. 14A depicts an exemplary workflow palette.

FIG. 14B depicts an exemplary driver palette.

FIGS. 15A and 15B depict an exemplary inventory palette.

FIGS. 16A and 16B depict various design aspects of an exemplary work order puzzle piece.

FIG. 16C depicts an exemplary work order form.

FIG. 16D depicts an exemplary fixed asset form.

FIGS. 16E, 16F and 16G depict exemplary edit fixed asset forms.

FIG. 17 depicts an illustrative route mapping generated by an exemplary dispatch application.

FIGS. 18A, 18B, 18C, 18D, 18E, 18F and 18G depict illustrative driver application screens generated by an exemplary driver application.

FIG. 19 depicts an exemplary context window for a driver's haul time report.

FIG. 20 depicts an exemplary context window for a fixed asset aging report.

FIGS. 21, 22, 23, 24, 25, 26, 27, 28 and 29 depict exemplary administration screens.

Like reference symbols in the various drawings indicate like elements.

### DETAILED DESCRIPTION OF ILLUSTRATIVE EMBODIMENTS

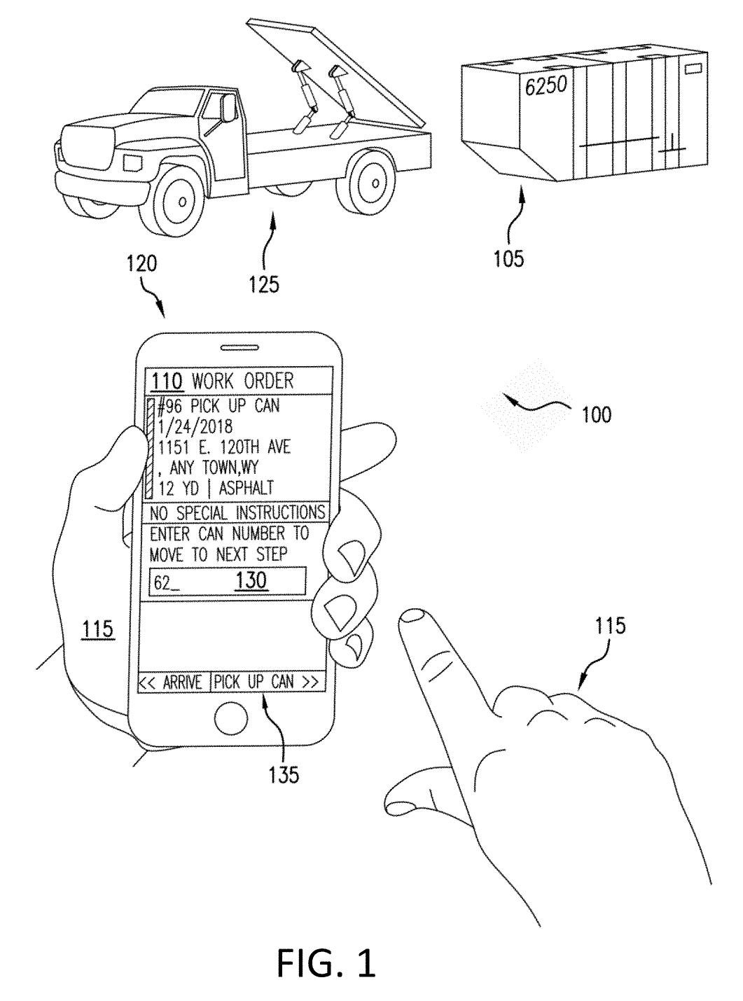

FIG. 1 depicts a driver perspective view of a deployment example of an exemplary movable asset tracking system at a worksite, the driver entering an asset number to move to the next step. A worksite 100 includes a movable fixed asset 105 (e.g., a roll-off waste container, can, shipping container, trailer). A work order 110 includes an order to pick up the movable fixed asset 105. A driver 115 receives the work order 110 on a mobile device 120. The mobile device 120 executes pre-programmed instructions of a driver application (app). The driver 115 starts the work order 110. The work order 110 has guided the driver 115 to the worksite 100, where the driver 115 has staged his asset transport truck 125 next to the movable fixed asset 105. In the depicted example, the workflow of the work order 110 is requesting the asset number 130 of the movable fixed asset 105. The driver 115 may move to the next workflow step 135 once the driver application validates the asset number 130 (of the movable fixed asset 105) entered by the driver 115. When the driver 115 enters a valid asset number 130 (of the movable fixed asset 105), the driver 115 may select the next step 135 in the workflow. If, for example, the driver 115 enters an invalid asset number (e.g., asset does not exist in a database, asset is not at the worksite 100), then the workflow requests the driver 115 to enter the valid asset number 130.

This “enforcement of valid asset number entries” may advantageously provide a substantially accurate accounting of the locations of a fleet of movable fixed assets (such as movable fixed asset 105). In various examples, the substantially accurate accounting of the locations of a fleet of movable assets may be recorded in a database. The database may be located in a cloud server, which may advantageously provide convenient access to drivers 115, dispatchers, or customers, for example. In some implementations, the database may be located at a fixed location, for example, at a dispatch hub. The fixed location may advantageously provide security and/or convenient maintenance. In various examples, the database may be distributed, which may advantageously provide automatic disaster recovery.

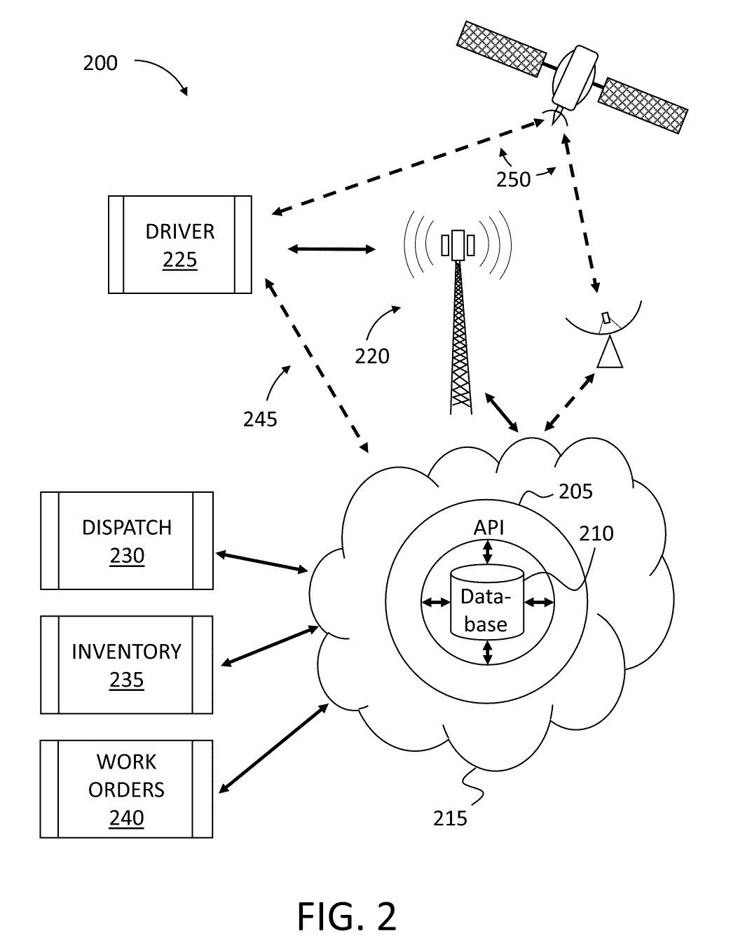

FIG. 2 depicts a network diagram of an exemplary movable fixed asset tracking and work order management system. In the depicted example, a movable fixed asset tracking system 200 includes a transportation/database application programming interface (API) 205. The API 205 governs access to a database 210. The API 205 and the database 210 exist within a network 215. The network 215 is communicatively coupled to a mobile network 220. The mobile network 220 is communicatively coupled to a driver application (app) 225. The network 215 is communicatively coupled to a dispatch app 230, an inventory app 235, and a work orders app 240.

The network 215 may be a cloud network or may be, for example, one or more of various wireless networks. In various implementations, the network 215 may be, for example, one or more of various wired networks. Further, the network 215 may employ various wireless networks and wired networks in combination. In various examples, the network 215 may be the Internet. A cloud-based computing system may include the API 205 and the database 210. Dashed lines represent optional communication interfaces.

The communication interface between the network 215 and the driver application 225 may be a direct wireless communication interface 245. The direct wireless communication interface may be a private citywide WIFI mesh, or a municipal wireless network, for example. In various examples, the communication interface between the network 215 and the driver application 225 may be facilitated by the mobile network 220 (e.g., cellular communications). In some examples, the communication interface between the network 215 and the driver application 225 may be facilitated via satellite network 250.

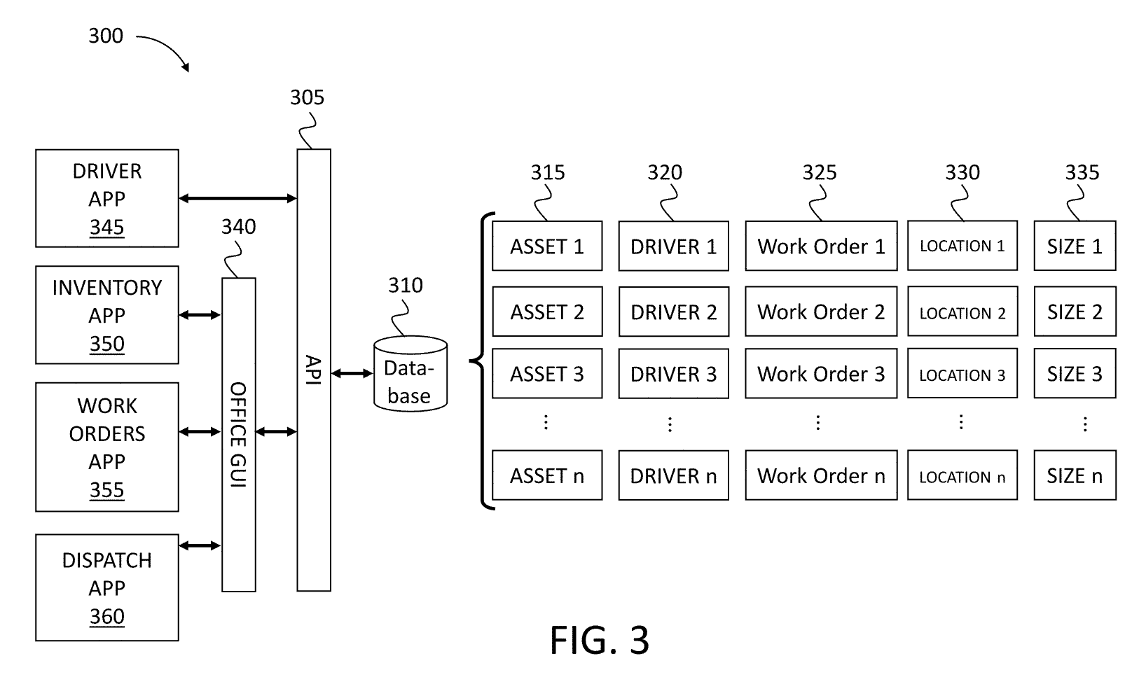

FIG. 3 depicts a data flow diagram of an exemplary movable fixed asset tracking and work order management system. A data flow diagram 300 of a movable fixed asset tracking and work order management system includes an API 305. The API 305 provides controlled access and updates to a database 310. The database 310 includes a collection of memory objects and or structures. In some implementations, the database may be a relational database (e.g., structured query language (SQL) database with relational indices). In the depicted example, the collection includes one or more asset objects 315, one or more driver objects 320, one or more work order objects 325, one or more location objects 330, and one or more size objects 335.

User interfaces to the API 305 are provided via an office graphic user interface (GUI) 340, and a driver application 345. The office GUI 340 includes an inventory application 350, a work orders application 355 and a dispatch application 360.

The database 310 is at the heart of the movable fixed asset tracking and work order management system. The API 305 provides controlled access and updates to the database 310. A real-time status of various objects 315-335, structures and/or variables in the database 310 of the management system may be kept up to date by the API 305.

Each asset memory object/structure 315 may include various properties representing an asset, for example, size, location, contents, serial number. Each driver memory object/structure 320 may include various properties representing the state of a driver, for example, driver's name, certifications, and hours logged. Each work order memory object/structure 325 may include various properties representing a work order, for example, customer's name, material, location, and addresses. Each location memory object/structure 330 may include various properties representing a location, for example, address, city and state. Each size memory object/structure 335 may include various properties representing a size.

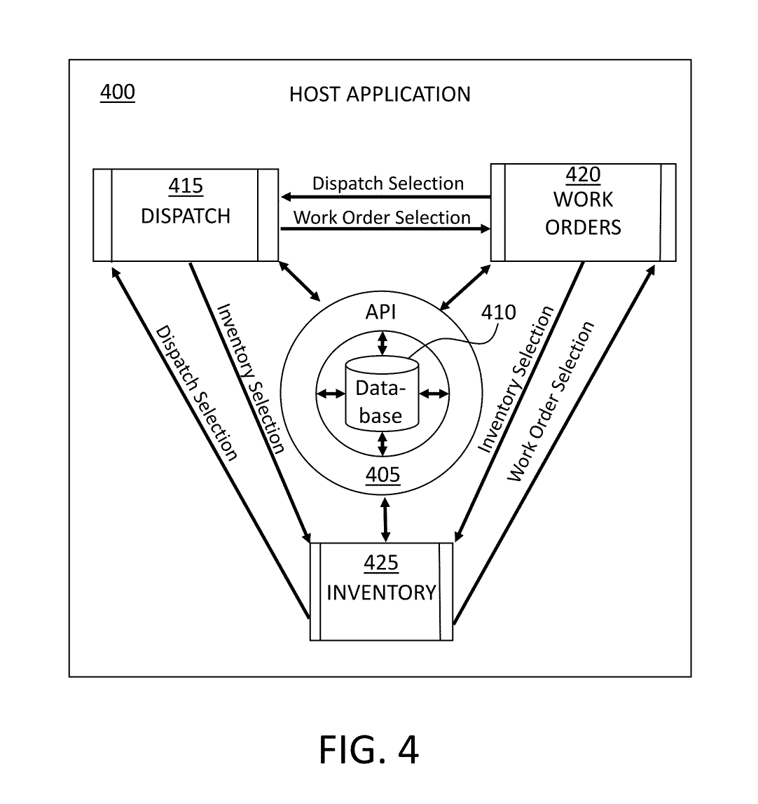

FIG. 4 depicts a data flow diagram of a host application of an exemplary movable fixed asset tracking and work order management system. A host application 400 includes an API 405. The API 405 continuously updates the database 410 based on inputs and outputs (I/O) from a dispatch module 415, a work orders module 420, and an inventory module 425.

A user may switch between each of the modules 415, 420, 425 by selecting an appropriate option button, shown as a dispatch selection arrow, a work order selection arrow, and an inventory selection arrow on FIG. 4.

Throughout this document, references to the “database” may refer to a central database (e.g., 210, 310, 410) governed by an API, such as APIs 205, 305, and 405. Each module within a host application and a driver application may receive data from the database and may update the database. Accordingly, the separate applications described herein may behave as one system with shared data. The API 405 may provide control of the data flowing in and out of the database. The API 405 may provide an “all or nothing” updating function. The “all or nothing” function may ensure that the integrity of each memory object/structure is completely accurate such that applications accessing the data may be provided fully updated information. Should the data update fail for any reason, the calling function may receive a failure signal from the API 405, indication that the API 405 has not changed data in the database. The API 405 may be responsible for resolving system race conditions, for example, when two or more applications attempt to update the same memory object/structure.

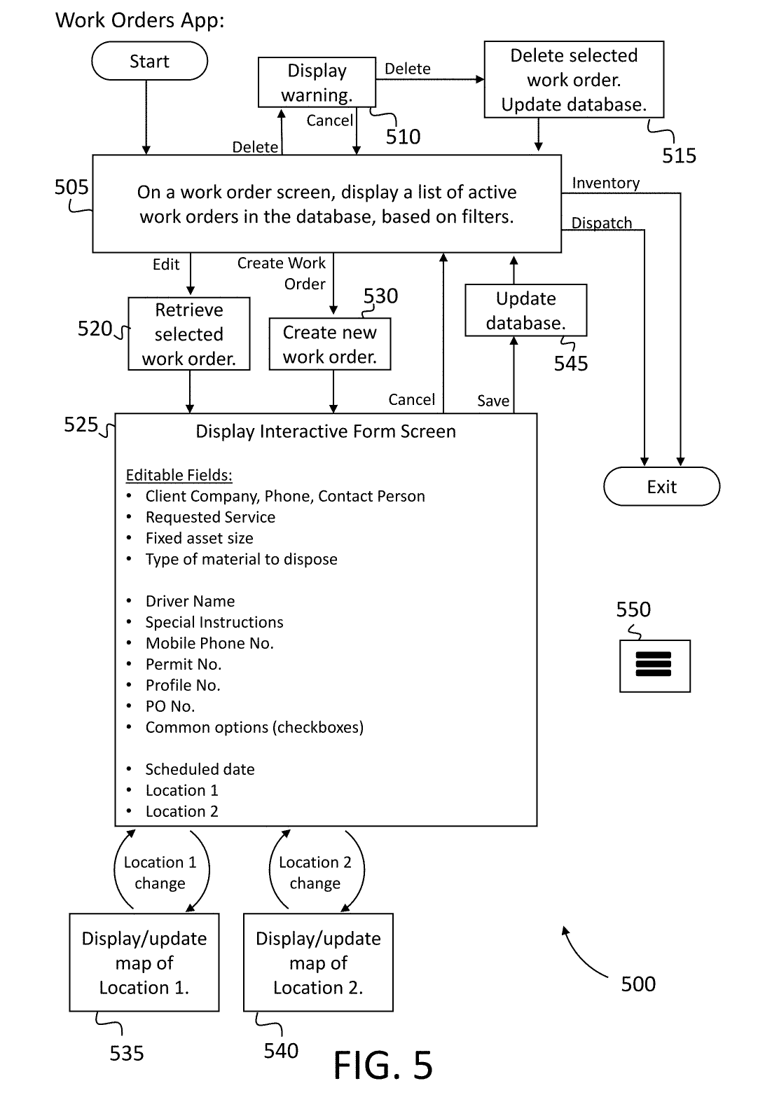

FIG. 5 depicts a flowchart of an exemplary work order application. A work order application 500 may be employed by a dispatcher. The work order application 500 begins execution at a step 505, where a work order screen, which includes a list of active work orders in the database, is displayed. The list of work orders may be optionally filtered by the dispatcher. The dispatcher may find benefit in the work order filter, for example, when the number of work orders becomes substantially large. At step 505, the work order application 500 provides edit and delete selections.

If, at step 505, the dispatcher selects a work order and selects delete, then a step 510 is executed. At step 510, a warning displays to the dispatcher of an impending work order deletion. If the dispatcher selects cancel, the work order remains intact and execution jumps back to step 505. If at step 510 the dispatcher confirms the deletion, then execution jumps to a step 515. At step 515 the selected work order is deleted from the database. Execution then jumps back to step 505.

If at step 505, the dispatcher selects a work order and selects edit, then a step 520 is executed. At step 520 the work order application 500 retrieves the dispatcher-selected work order. Next at a step 525 the dispatcher's screen displays an interactive form with a collection of pre-populated editable fields, with information from the selected work order.

If at step 505, the dispatcher selects “create work order”, then step 530 is executed. At step 530 a blank work order may be created in the database. In some examples, an auto indexer may pull a next available (new) work order number. Next at step 525 the dispatcher's screen displays the interactive form with a collection of blank editable fields.

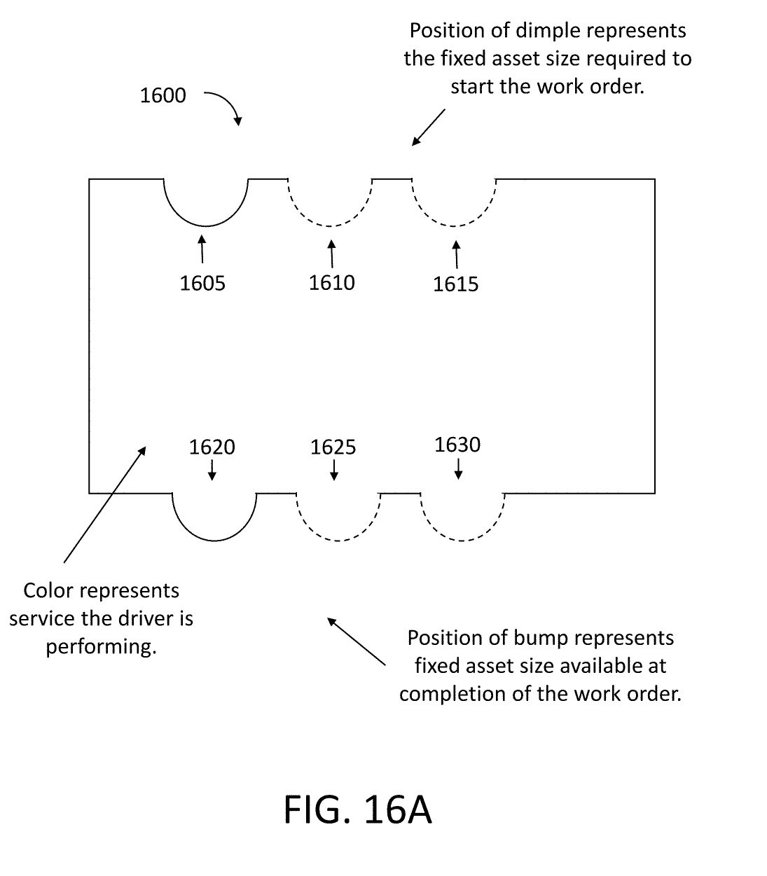

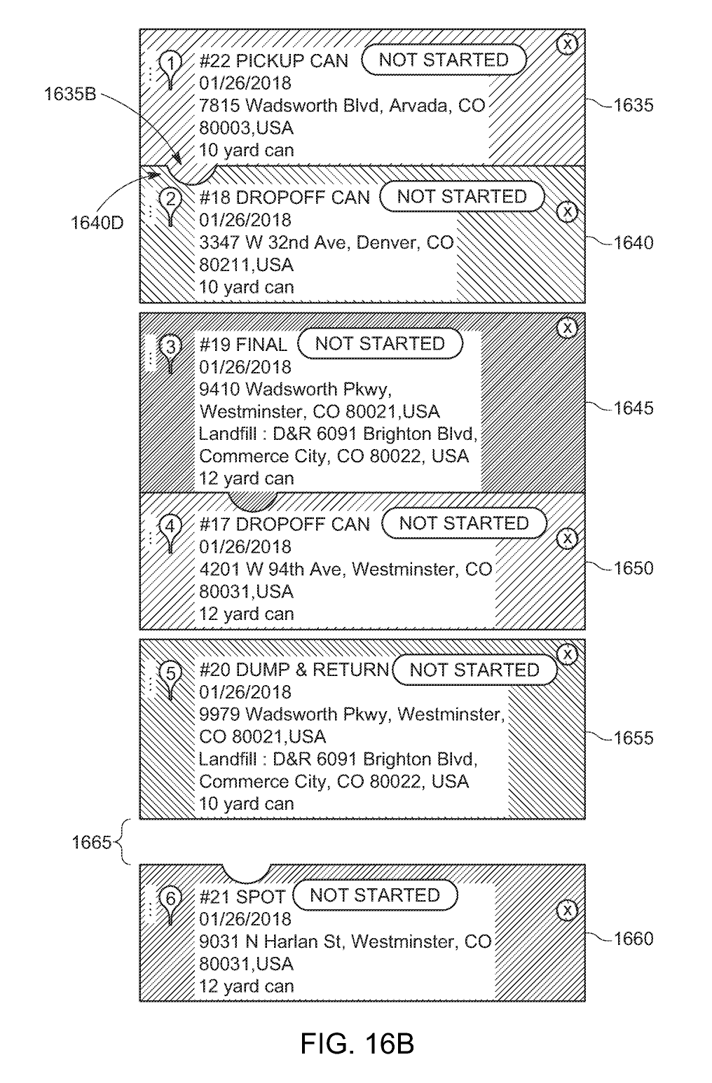

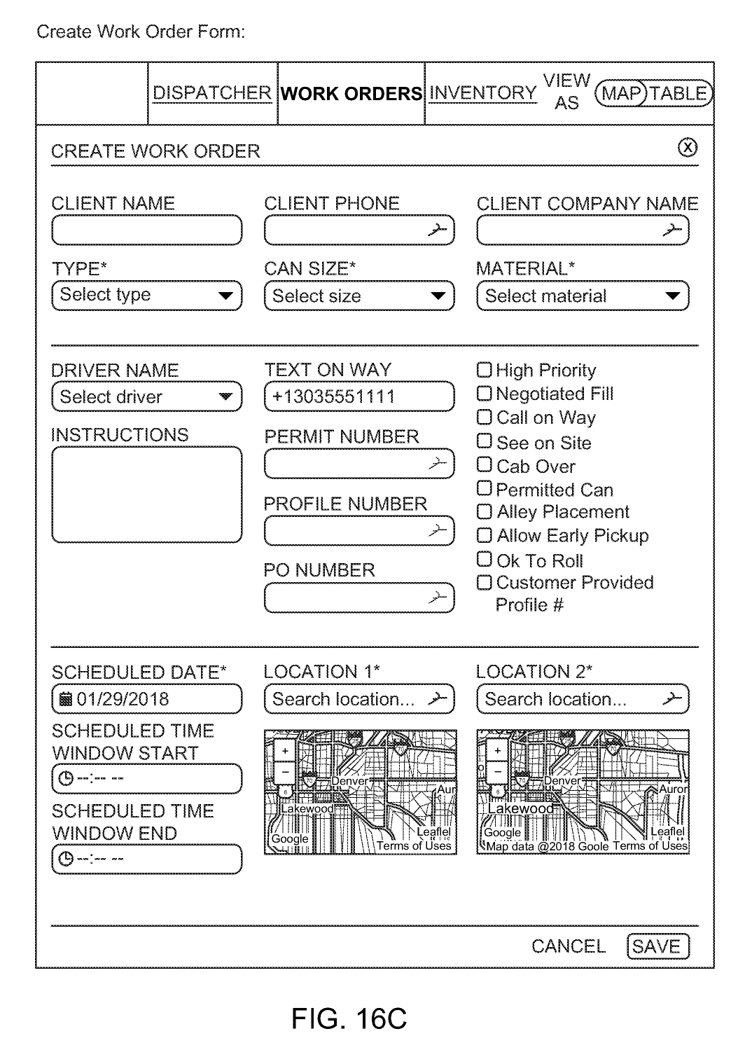

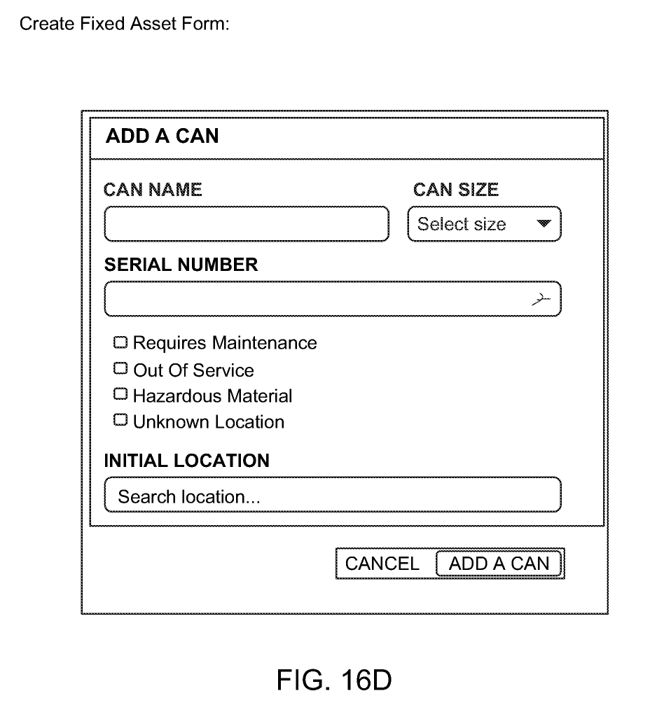

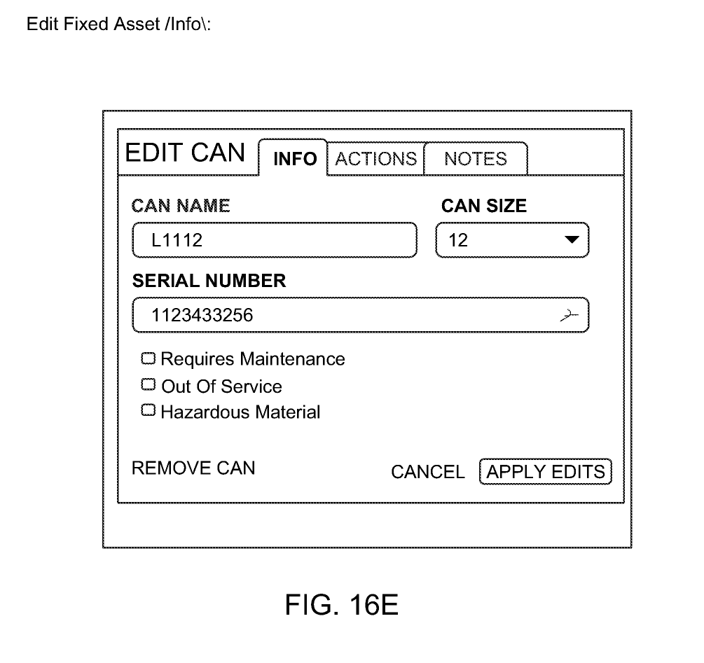

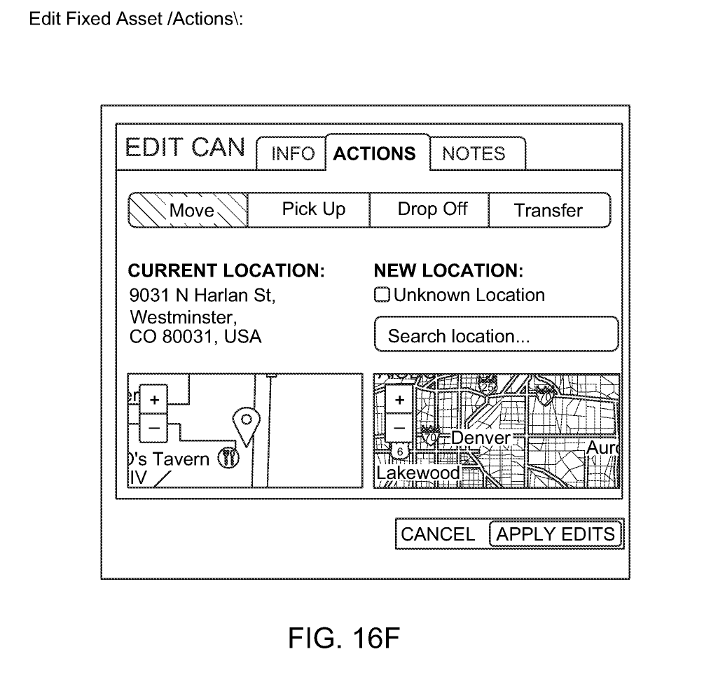

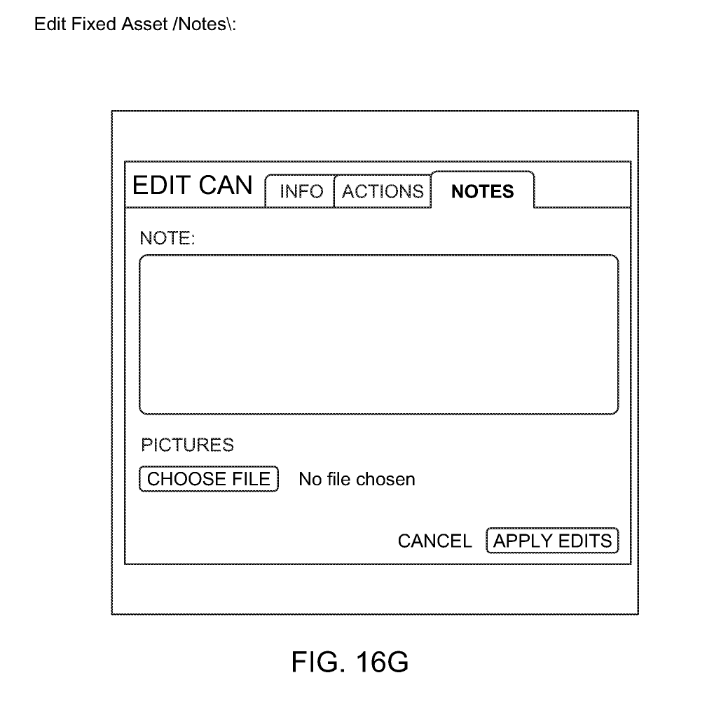

The interactive form in step 525 may provide the dispatcher with various editable fields. For example, the dispatcher may be permitted to enter/edit a client's company, phone number, and contact person. In a “requested service” editable field, the dispatcher may, for example, pull down a menu containing various services offered. The dispatcher may complete the location editable field. In some examples, and depending on the service offered, the work order form may include one or more locations. An exemplary work order form is depicted in more detail with reference to FIG. 16C.

In various examples of requested service, one or more locations may be entered by the dispatcher. For example, for a “Spot” service, where a fixed asset is requested by a customer, only one location may be required. In some examples, such as a “Dump and Return” service where a fixed asset is picked up at one location (e.g., location-1) and emptied at separate location, such as a way-point, (e.g., location-2), two locations may be required.

Within the location-1 section of the interactive form in step 525, the dispatcher may enter an address. When the work order application 500 detects an initial address selection or a change to the address selection, then step 535 is executed. At step 535, the location selected in the location-1 section of the interactive form is displayed/updated on the location-1 map.

Within the location-2 section of the interactive form in step 525, the dispatcher may enter an address. When the work order application 500 detects an initial address selection or a change to the address selection, then step 540 is executed. At step 540, the location selected in the location-2 section of the interactive form is displayed/updated on the location-2 map. In various examples, a second location (e.g., location-2) may not be required.

If at step 525 save is selected, then step 545 is executed. At step 545 the database is updated with the information from the editable fields. If at step 525 cancel is selected, then execution jumps to step 505 without updating the database. In various implementations, at step 530, the work order may be created, but may not be saved in the database until after it is saved in step 545.

If at step 505, the dispatcher selects Inventory or Dispatch, then the Work Orders application is exited. For these two selections, the associated Inventory or Dispatch applications are executed after the Work Orders application is exited. In the depicted example of FIG. 5, whenever data from the database is retrieved or updated, an API, such as the API 305, may be called to govern the actions taken on the database, for example.

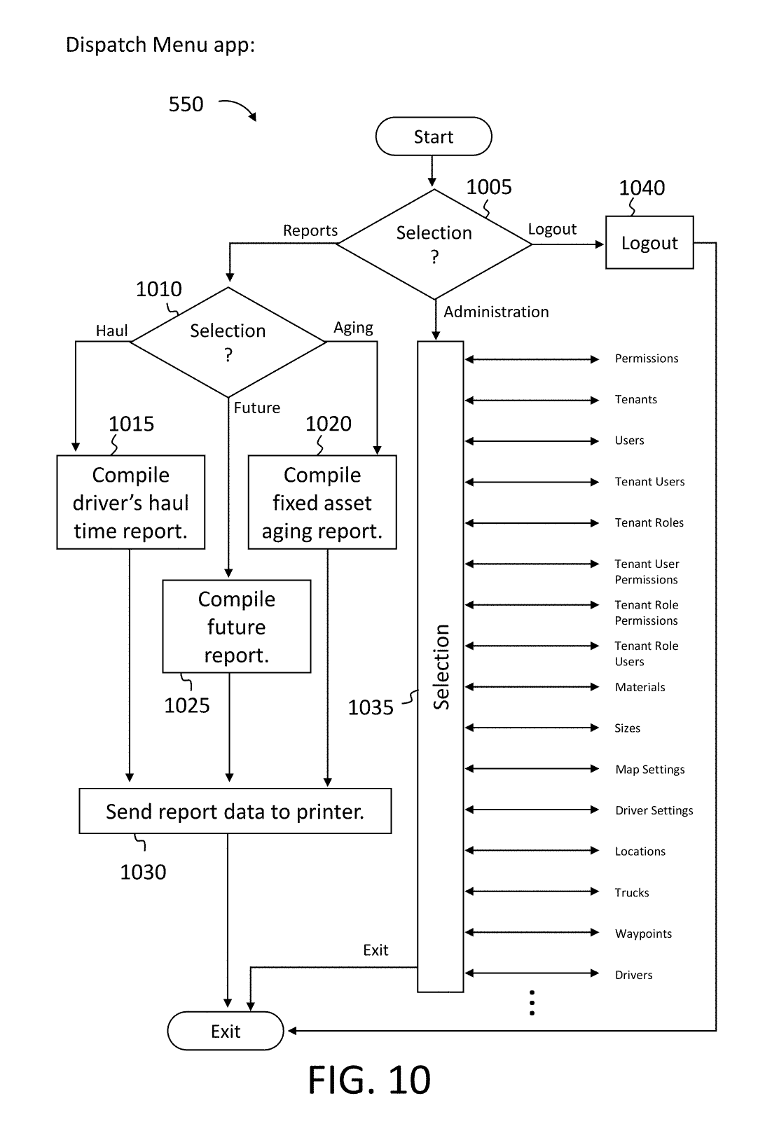

The work orders application 500 includes a dispatch menu 550. The dispatch menu 550 is described in further detail with reference to FIG. 10.

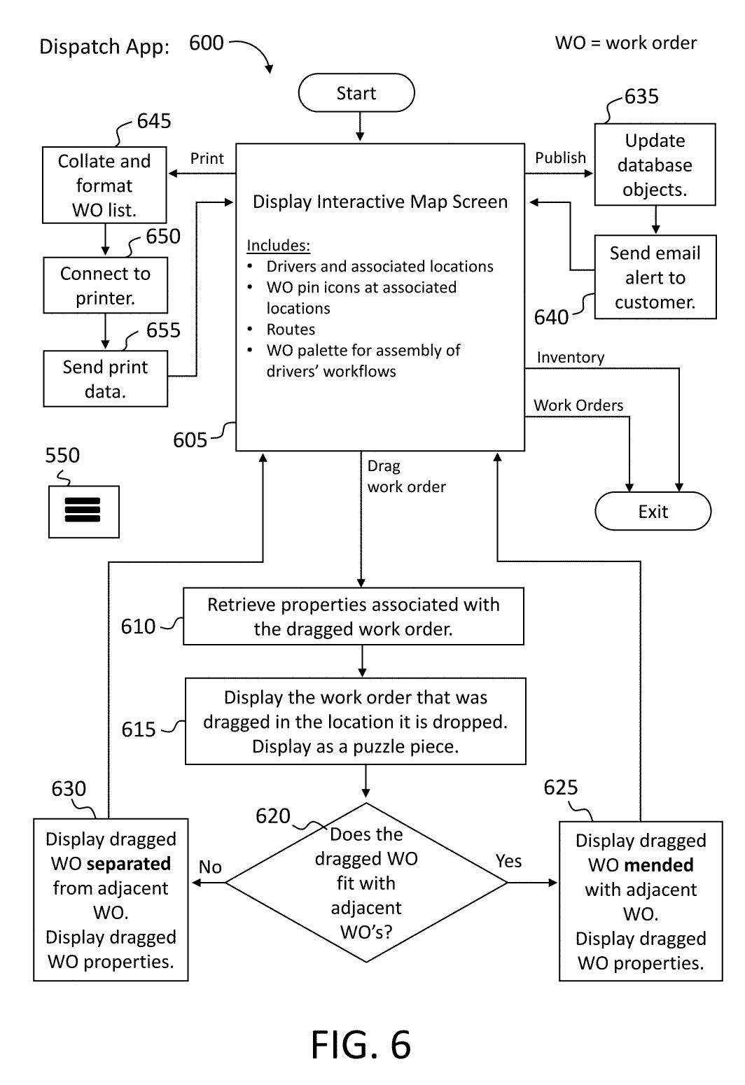

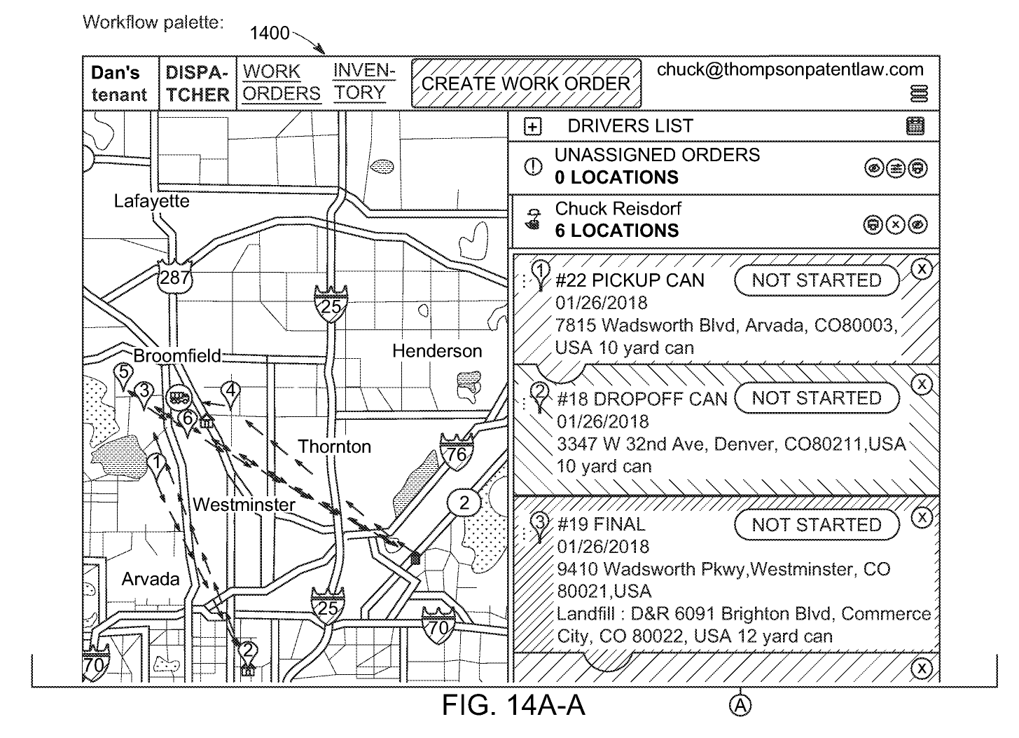

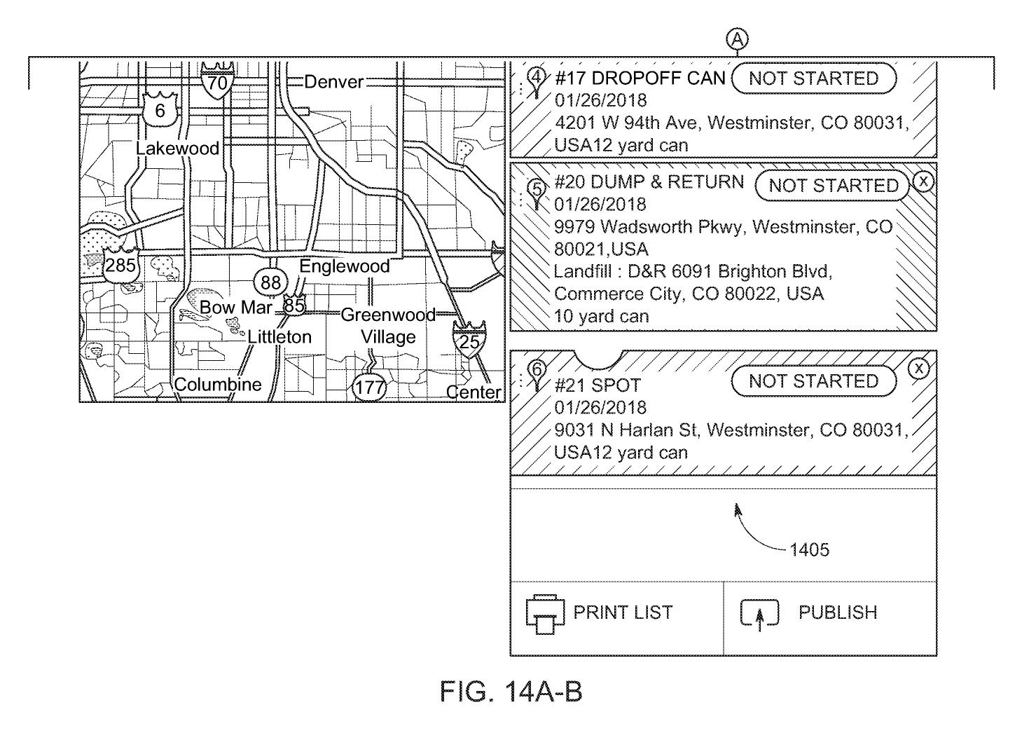

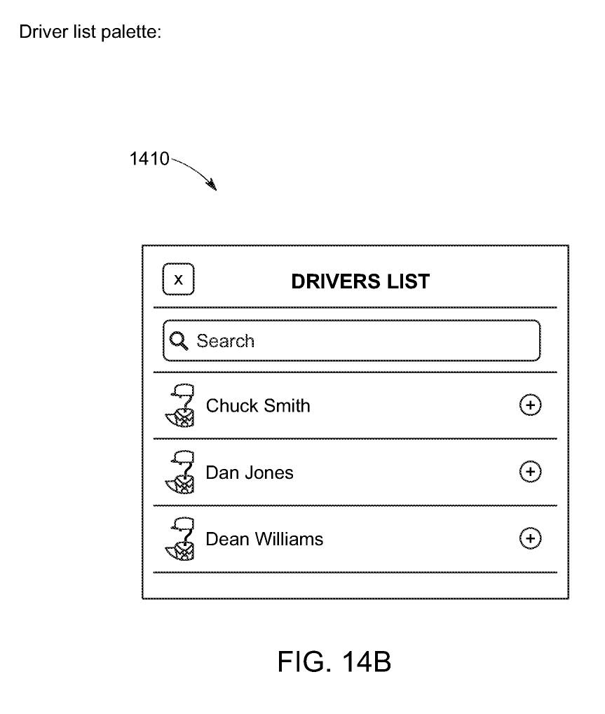

FIG. 6 depicts a flowchart of an exemplary dispatch application. A dispatch application 600 may be employed by a dispatcher. The dispatch application 600 begins execution at a step 605, where execution displays a dispatch screen. The dispatch screen includes an interactive map. The interactive map includes various icons for drivers, work orders, and routes. The various icons are placed on the interactive map in their associated locations. The dispatch screen includes a workflow palette for assembly of workflows. Each driver may be associated with the unique workflow. On the workflow palette, the dispatch application 600 displays the current workflow for a specific driver in response to the dispatcher selecting that specific driver. The workflow palette is described in more detail with reference to FIG. 14A.

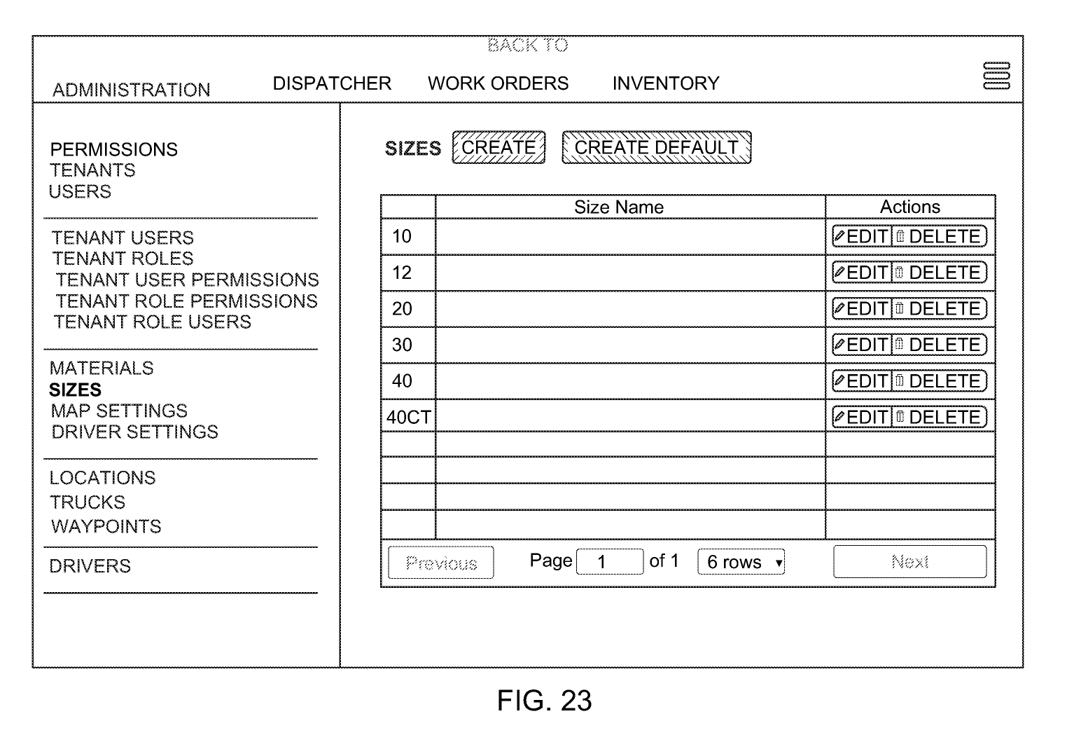

The dispatcher may interact with the work order icons, by dragging and dropping them into the workflow palette. When the work orders are dragged within the interactive map, execution jumps to step 610. At step 610, the dispatch application retrieves properties associated with the dragged work order from the database. Next at step 615, the dispatch application displays one or more of the properties retrieved from the database in a work order puzzle piece which is displayed in the work order palette. The work order puzzle pieces are described in more detail with reference to FIGS. 16A and 16B. One edge of the work order puzzle pieces includes a specific shape associated with the state of the transport vehicle at the start of the work order. Another edge of the work order puzzle piece includes a specific shape associate with the state of the transport vehicle at the end of the work order. States of the transport vehicle may include, for example, no fixed assets, a 10-yard fixed asset, a 20-yard fixed asset, a 40-yard fixed asset. Each state may be associated with a specific shape. In some instances, the specific shape may be referred to as a jig. The jigs and associated advantages are described in more detail with reference to FIG. 23.

In an illustrative example, work order #1 may have an output state of a 10-yard roll-off container loaded on a transport vehicle. The input state of work order #2 may require a 10-yard roll-off container. Accordingly, the trailing edge of the work order #1 puzzle piece may include jig bump of shape x in location y. Further, the leading edge of the work order #2 puzzle piece may include jig dimple of shape x in location y. Since the output state of work order #1 is compatible (fits with) the input of work order #2, it may follow that the work order #1 puzzle piece leading trailing edge may fit with (mend with) the leading edge of work order #2 puzzle piece.

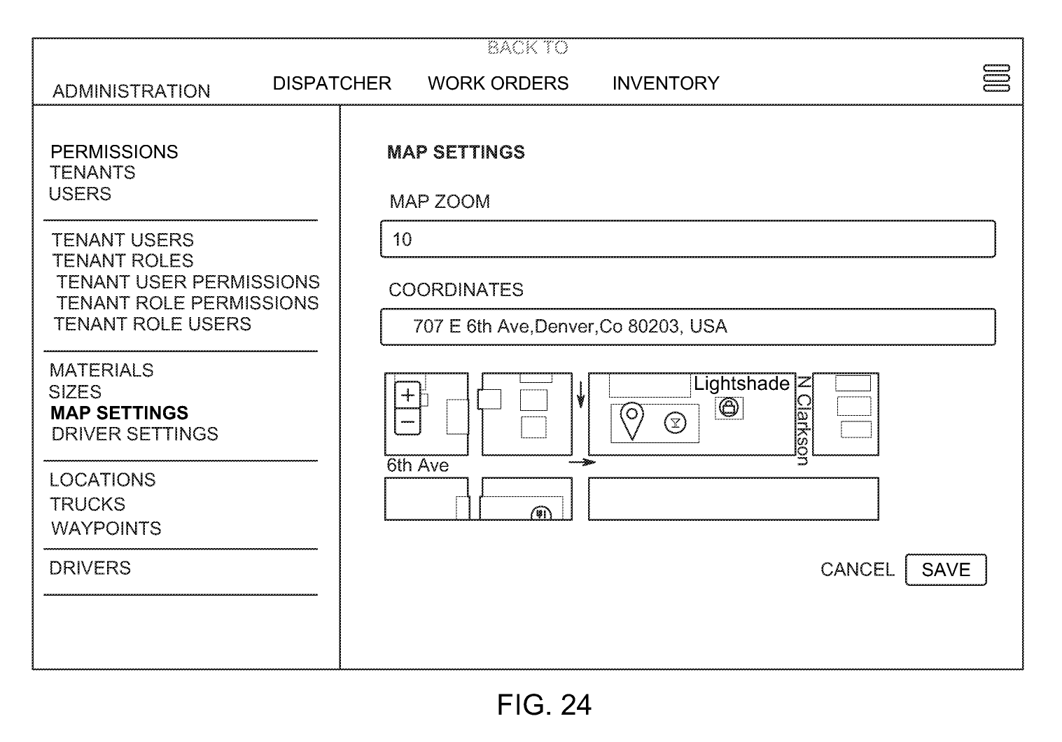

In this manner, a dispatcher may design workflows that are compatible, which may advantageously reduce dead-heading and wasted trips to a retention yard. The intuitive nature of the snap together work order puzzle pieces in the workflow palette may advantageously speed up workflow compilation, reduce mistakes, and reduce stress. An interconnection route shows graphically on the interactive map, interconnecting the distances between work order locations and may be based on their chronological order in the workflow palette. The routes are described in more detail with reference to FIG. 24. In various examples, the input state may be a start state. In some implementations, the output state may be a completion state or an end state.

In some examples, the work order puzzle pieces may be linked chronologically from top to bottom within the workflow palette. In some examples, the work order puzzle pieces may be linked chronologically from bottom to top. In some examples, the work order puzzle pieces may be linked chronologically from left to right. In some examples, the work order puzzle pieces may be linked chronologically from right to left. In some examples, routes between work order locations are shown on the map to further aid the dispatcher in making workflow decisions based on traveling distances. For instance, if two or more work orders are compatible with a second work order (they fit together) the dispatcher may “try” each compatible piece to determine the best choice based on overall distance.

At step 620 the dispatch application 600 determines the compatibility of the dragged work order puzzle piece with the adjacent puzzle pieces in the drop location. At step 620, if the puzzle pieces fit together, execution jumps to step 625. At step 625, the dispatch application 600 displays the puzzle pieces mended together. Execution then jumps back to step 605. At step 620, if the puzzle pieces do not fit together, execution jumps to step 630. At step 630 the dispatch application 600 displays the puzzle pieces separated. Execution then jumps back to step 605.

When the dispatcher wishes to push the workflow to the driver, the dispatcher may select publish from step 605. Execution then jumps to step 635. At step 635, the work orders and the work order sequence (workflow) is updated in the database, which eventually gets pushed to the driver application. Next in step 640, an email message is sent to the email addresses associated with each work order. This automatic email alerting feature may advantageously reduce dispatcher time authoring individual email messages, making phone calls and/or answering the phone. The automatic email alerting feature may also advantageously mitigate mistakes in reporting status and may provide timely work order status to customers.

The dispatcher may print a list of work orders. At step 605, if the dispatcher selects the print option execution jumps to step 645. At step 645, the dispatch application 600 collates and formats the work order list. Next, at step 650 the application connects to a printer. Finally, at step 655, the application sends the print data to the printer.

If at step 605, the dispatcher selects Inventory or Work Orders, then the Dispatch application 600 is exited. For these two selections, the associated Inventory or Work Order applications are executed after the Dispatch application is exited. In the depicted example of FIG. 5, whenever data from the database is retrieved or updated, an API, such as the API 305, may be called to govern the actions taken on the database, for example.

The work orders application 600 includes the dispatch menu 550. The dispatch menu 550 is described in further detail with reference to FIG. 10.

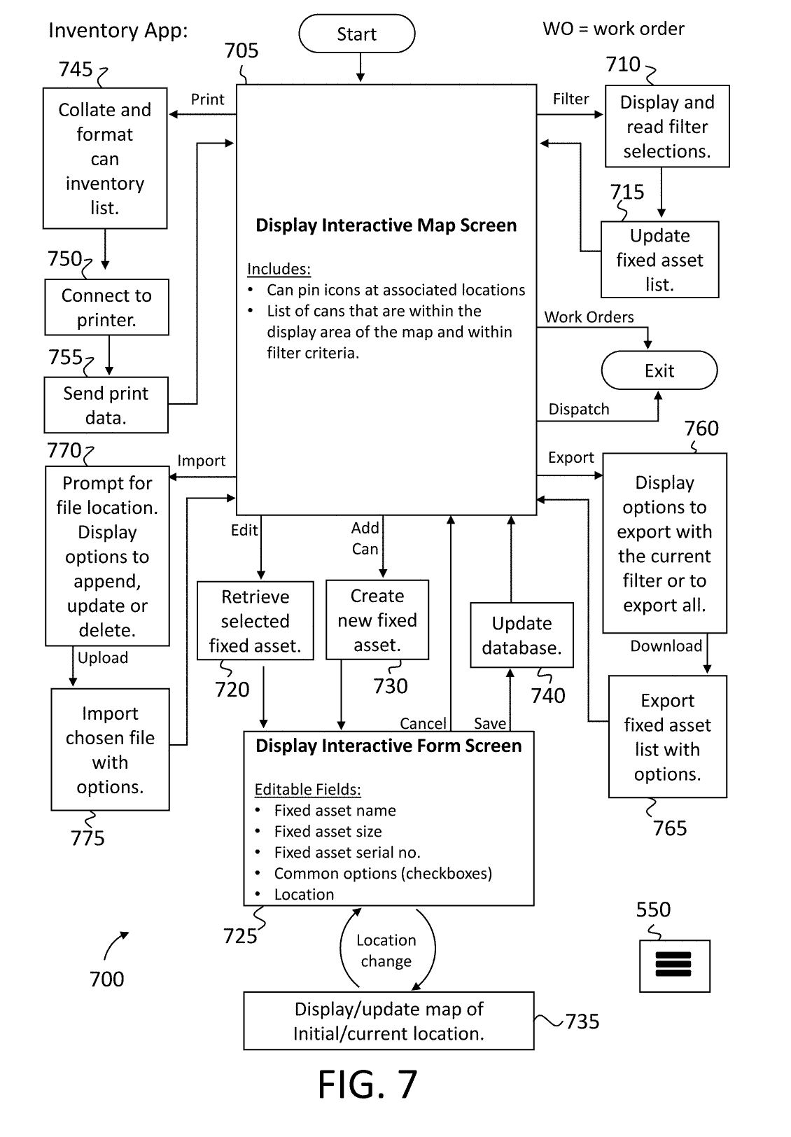

FIG. 7 depicts a flowchart of an exemplary inventory application. An inventory application 700 may be employed by a dispatcher. The inventory application 700 begins execution at a step 705, where execution displays an inventory screen. The inventory screen includes an interactive map. The interactive map includes location indication icons for all fixed assets within the map view area. The inventory screen includes an inventory palette. The inventory palette includes a list of fixed assets in the database that are within the map view area. The dispatcher may selectively edit or delete the fixed assets in the list using the associated selection buttons.

In some examples, as the listed assets are selected, the associated location indication icons may be highlighted. Accordingly, as the location indication icons are selected, the associated listed assets may be highlighted. The highlighting feature may advantageously aid dispatchers in identifying assets, associated locations and associated properties (e.g., sizes).

At step 705, the dispatcher may filter the list of fixed assets, which may advantageously reduce clutter, and to increase search speed. If the dispatcher selects filter, then execution jumps to step 710. At step 710 the inventory application reads the filter setting from the dispatcher. Next at step 715, the fixed asset list displayed is updated based on the applied filters.

If at step 705, the dispatcher selects a fixed asset and subsequently selects edit, then a step 720 is executed. At step 720 the inventory application 700 retrieves the dispatcher-selected fixed asset. Next at a step 725 the dispatcher's screen displays an interactive form with a collection of pre-populated editable fields with information from/about the selected fixed asset memory object in the database.

In various implementations, a movable fixed asset may be a can (e.g., a trash can, roll-off waste can/container). If at step 705, the dispatcher selects “create can,” then step 730 is executed. At step 730 a blank fixed asset may be created in the database. In some examples, an auto indexer may pull a next available (new) can number. Next at step 725 the dispatcher's screen displays the interactive form with a collection of blank editable fields.

The interactive form in step 725 may provide the dispatcher with various editable fields. An exemplary fixed asset form is depicted in more detail with reference to FIG. 16D.

Within the location section of the interactive form in step 725, the dispatcher may enter an address for the initial location. When the inventory application 700 detects an initial address selection or a change to the address selection, then step 735 is executed. At step 735, the location selected in the location section of the interactive form is displayed/updated on the location map.

If, at step 725, save is selected, then step 740 is executed. At step 740 the database is updated with the information from the editable fields. If, at step 725, cancel is selected, then execution jumps to step 705 without updating the database.

The dispatcher may print a list of fixed assets. At step 705, if the dispatcher selects the print option execution jumps to step 745. At step 745, the inventory application 700 collates and formats the fixed asset list. Next, at step 750 the application connects to a printer. Finally, at step 755, the application sends the print data to the printer.

If at step 705, the dispatcher selects Work Orders or Dispatch, then the Inventory application is exited. For these two selections, the associated Work Orders or Dispatch applications are executed after the Inventory application 700 is exited. In the depicted example of FIG. 7, whenever data from the database is retrieved or updated, an API, such as the API 305, may be called to govern the actions taken on the database, for example.

The dispatcher may export and/or import the database. This may be advantageous for data backups and/or for relocation of the database. In some examples, the dispatcher may export a list of fixed assets based on a filter setting. At step 705 if the dispatcher selects export, execution jumps to step 760. At step 760 the inventory application displays options to export with the current filter options or to export all. Next at step 765 the list of fixed assets is exported with the selected option. In some examples, the inventory application 700 may request a path location to store the exported data. At step 705 if the dispatcher selects import, execution jumps to step 770. At step 770 the inventory application prompts the dispatcher for a location to save the data. The inventory application 700 may prompt the dispatcher to append the current data with the new data, perform an update of the current data with the new data, or to replace the current data with the new data. If upload is selected by the dispatcher, execution jumps to step 775. At step 775, the dispatch application 700 imports the selected file with the chosen options.

The work orders application 700 includes the dispatch menu 550. The dispatch menu 550 is described in further detail with reference to FIG. 10.

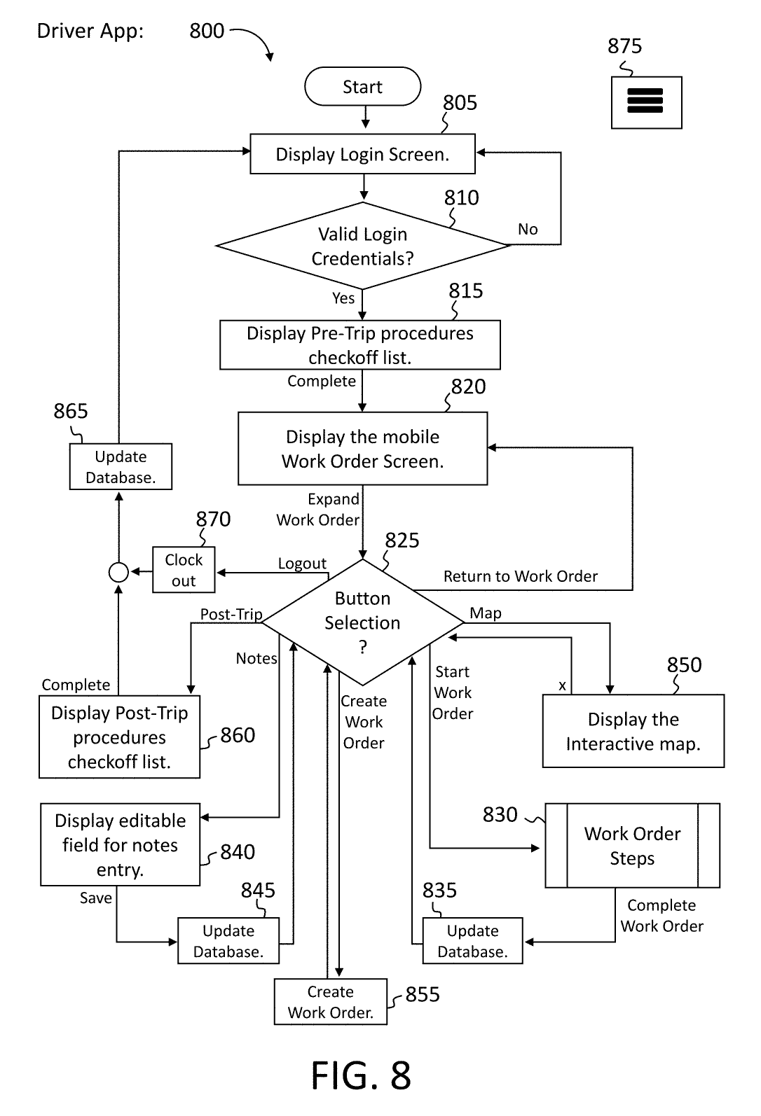

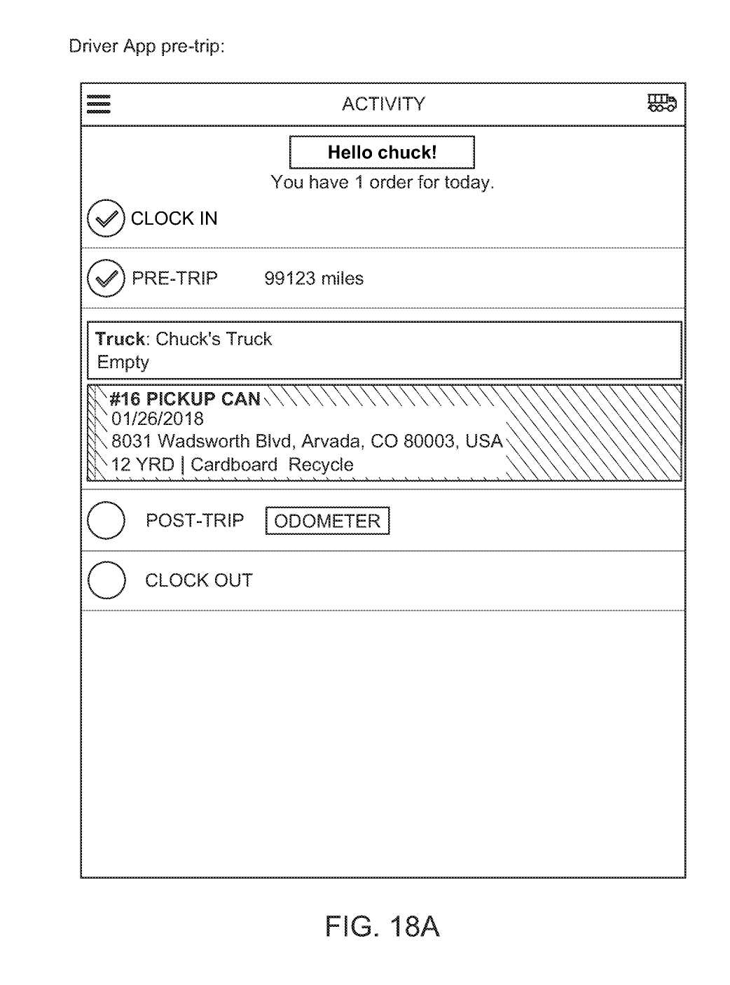

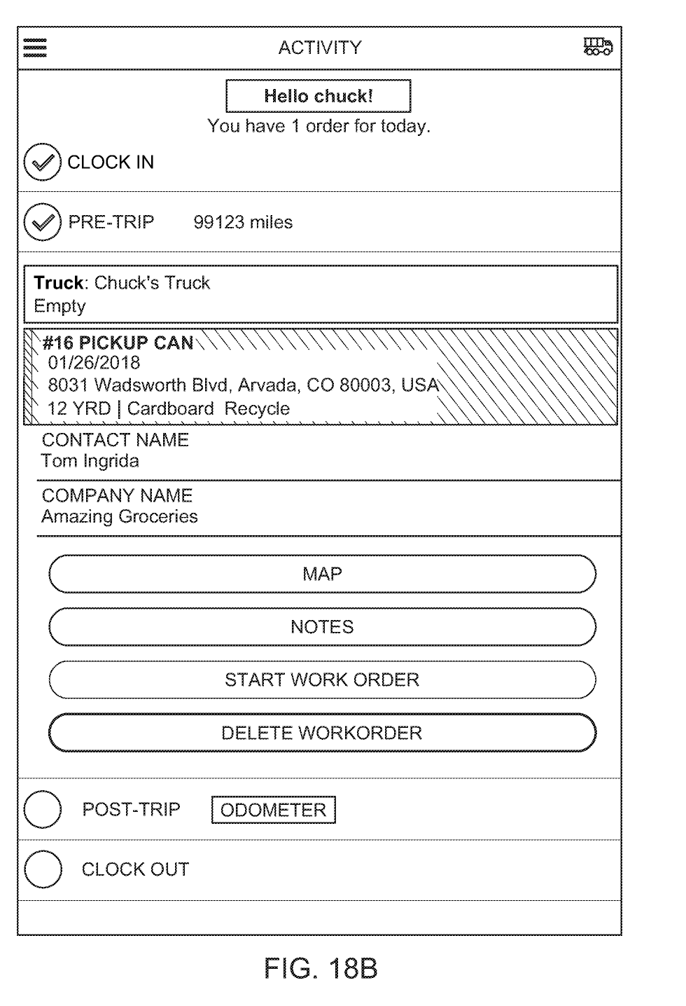

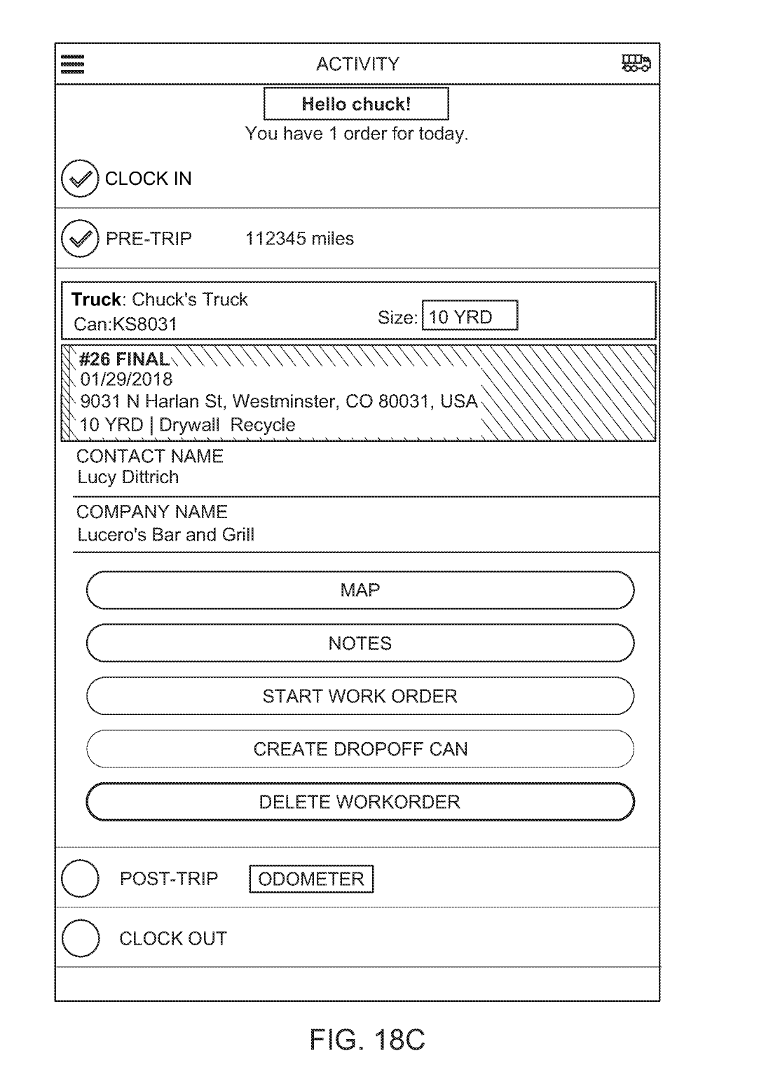

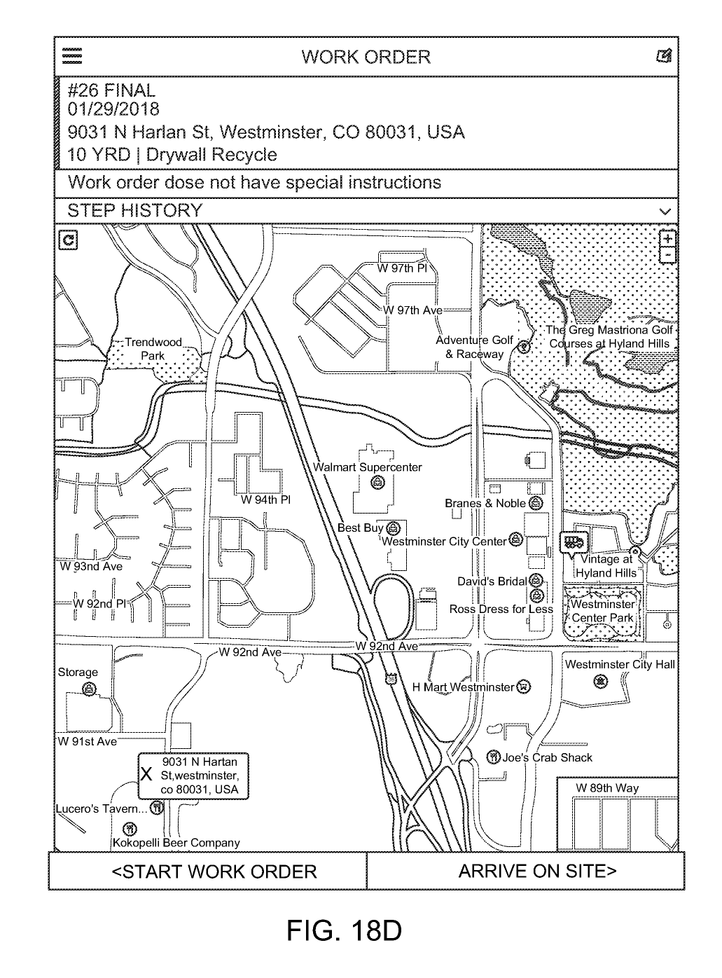

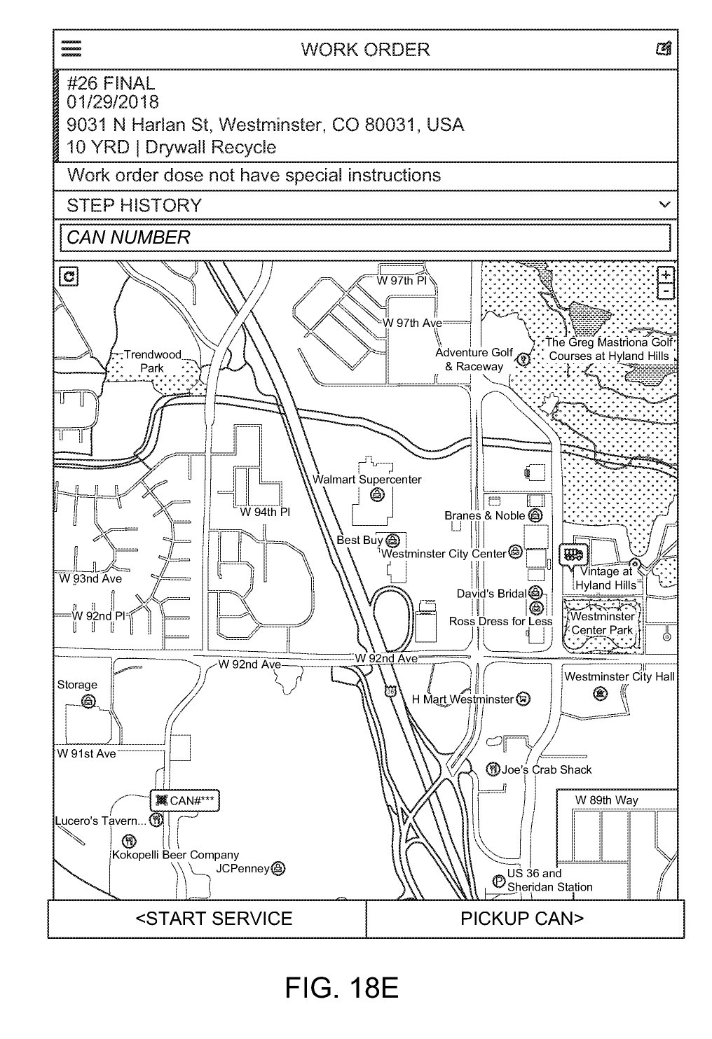

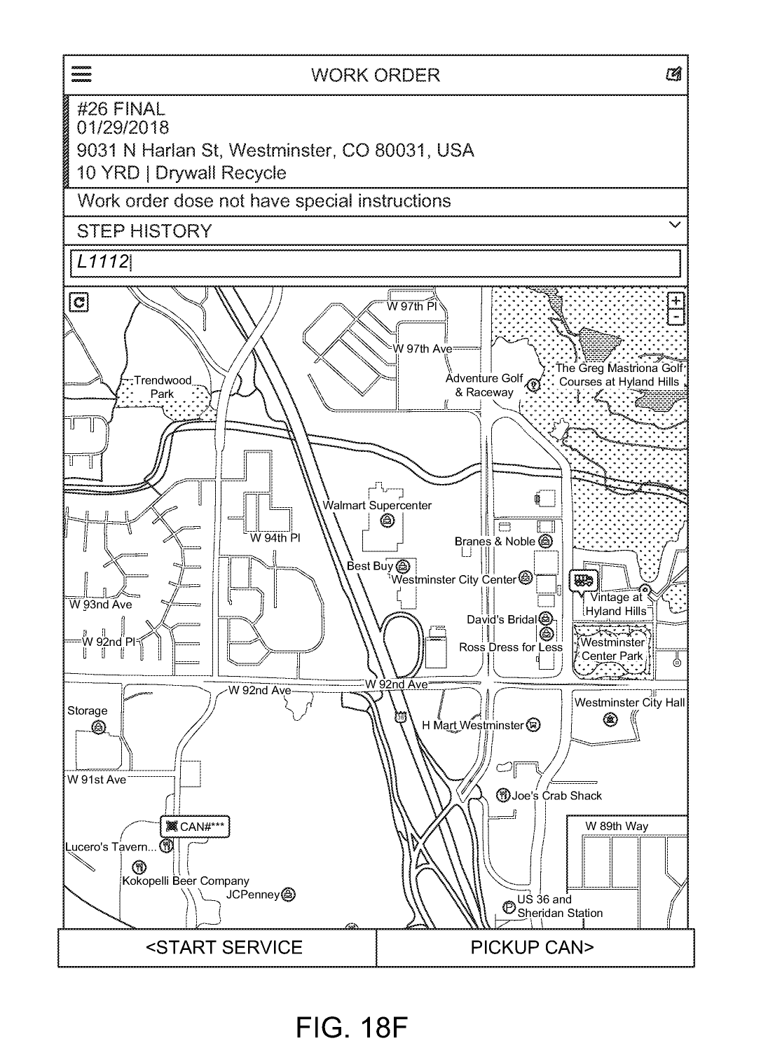

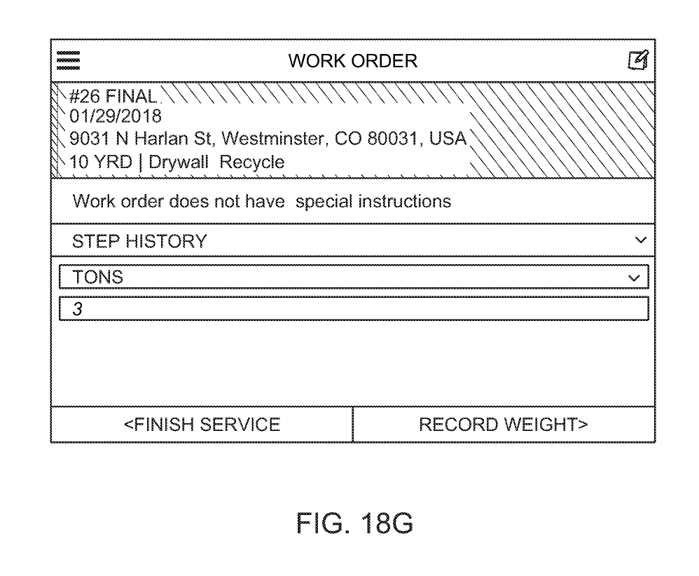

FIG. 8 depicts a flowchart of an exemplary driver application. A driver application 800 may include pre-programmed instructions on a mobile device. The mobile device may be employed by a fleet of drivers, each driver possessing a unique mobile device executing the driver application. The driver application 800 begins execution at a step 805, where it displays a login screen. The driver may enter a username and password and select login, for example. Next, at step 810 the driver application 800 determines the validity of the entered username and password. If the username and password are valid, then the driver is logged into the application. Next, at step 815 the driver application 800 displays a Pre-Trip checkoff list at step 815. An exemplary Pre-Trip checkoff list is presented in more detail with reference to FIG. 18A. In an illustrative example, a driver may log in, check-select “Clock in,” perform pre-trip procedures (as outlined company guidelines, for example) enter the odometer reading of his truck, and finally check-select pre-trip.

The term check-select may be defined as a user (e.g., driver) touch-selecting a checkoff icon on an interactive display screen associated with a step. In response to the touch-selection the interactive display screen may display a positive indication (e.g., checkmark) that the checkoff icon has been touch selected. The positive indication may indicate that the user (e.g., driver) has indicated that the associated step has been performed.

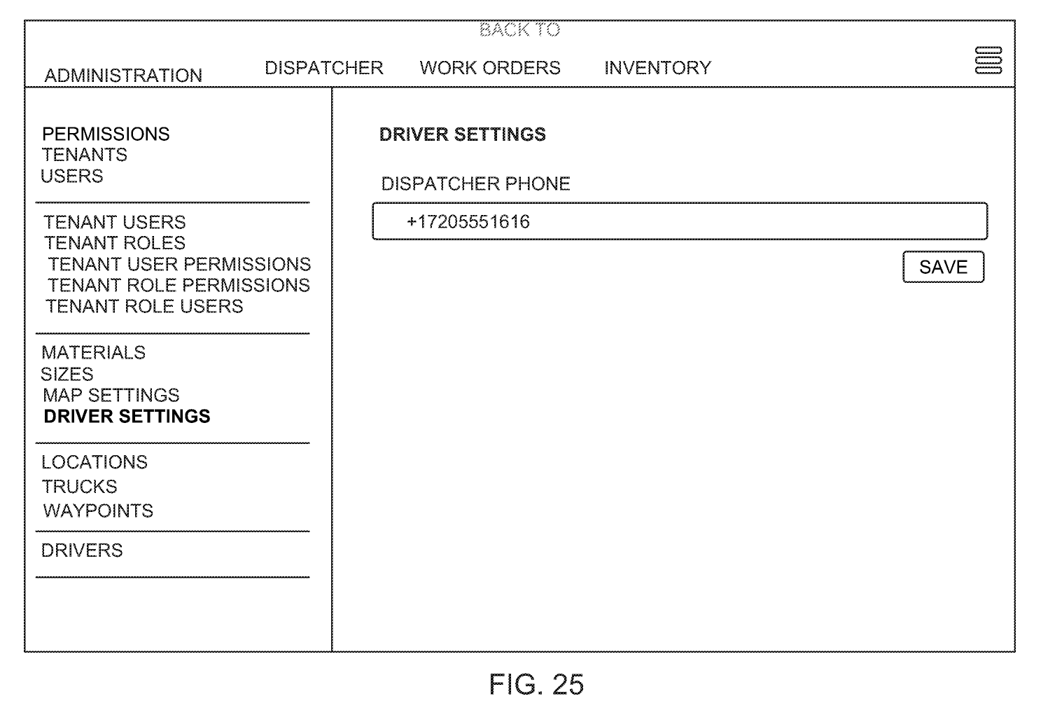

The driver application 800 remains at step 815 until all the pre-trip checks are check-selected by the driver. Once complete, execution continues to step 820. At step 820, the driver application 800 retrieves the current work orders from the database that are associated with the driver. The driver application 800 then displays the work orders on a work order screen. An exemplary driver application work order screen is presented in more detail with reference to FIG. 25A and FIG. 25B. If a work order is selected by the driver, then the driver application expands the work order to present further work order details. Once the work order is expanded, execution continues to step 825. At step 825, the driver application presents several options to the driver. In the depicted example, the driver application 800 presents a start work order option, a notes option, a map option, a post-trip option, a return to work order (go back) option, a logout option, and a create work order option.

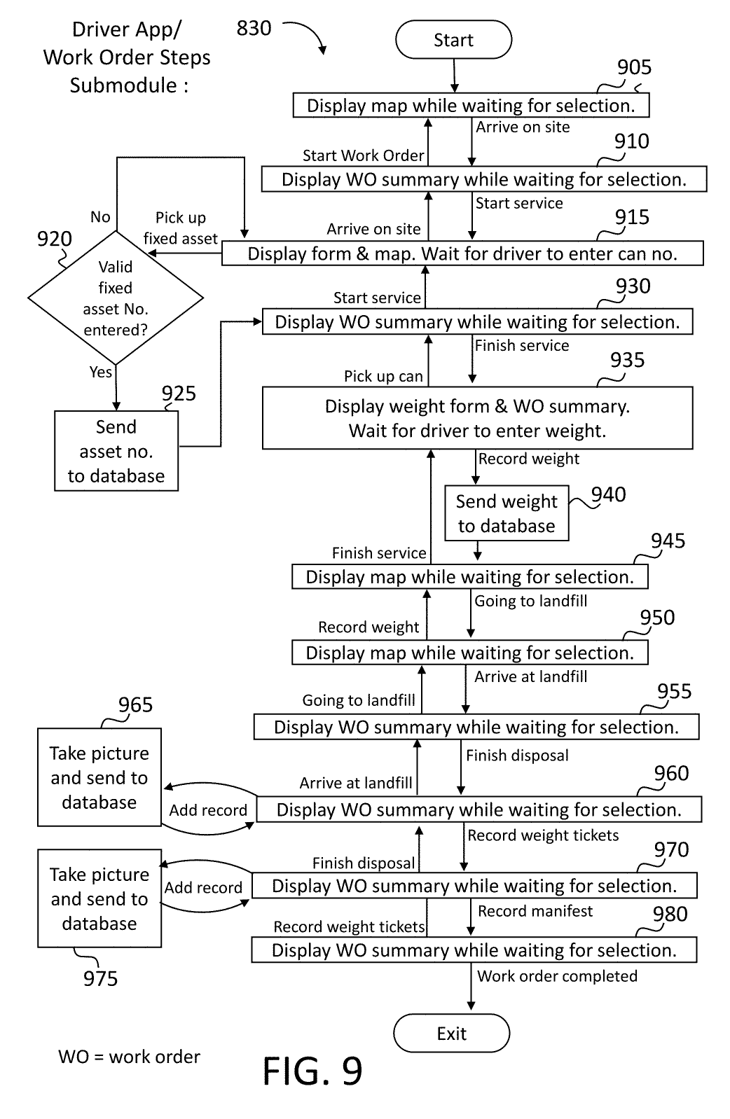

If, at step 825, the start work order option is selected, then execution jumps to a work order steps submodule 830. The work order steps submodule 830 may guide the driver through a specific workflow associated with the specific type of work order in which the driver is engaged. The work order steps submodule 830 is described in more detail with reference to FIG. 9. Once the work order steps submodule 830 is completed, execution jumps to step 835. At step 835, the database is updated, and execution continues back to step 825.

If, at step 825, the notes option is selected, then execution continues to step 840. At step 840, the driver application displays an editable field, into which the driver may enter notes. For example, the driver may explain an inability to complete a work order. If a save option is selected, then the work order with the notes is updated in the database at step 845. Execution then jumps back to step 825.

If, at step 825, the map option is selected, then execution continues to step 850. At step 850 the driver application 800 displays an interactive map focused on the geographic area surrounding the work order location. When close is selected, execution jumps back to step 825. In various embodiments, a driver may select a back button, or may select a driver menu 875 to exit the map and to jump back to step 825.

If, at step 825, the return to work order (e.g., go back) option is selected, then execution jumps back to the work orders screen at step 820. If, at step 825, the create work order is selected, then execution continues to step 855. At step 855 the driver application 800 displays a work order creation screen. The driver may fill in the editable fields within the work order form and select save. The new work order may then be created in the database.

If, at step 825, the post-trip option is selected, then execution continues to step 860. At step 860 the driver application 800 displays a post-trip procedures screen. Once all the checks are completed at step 860, then execution jumps to step 865. At step 865 the database is updated, and execution jumps back to the login screen at step 805.

If, at step 825, the logout option is selected, then the driver is automatically clocked out at step 870. Next, the database is updated at step 865, and then execution jumps to the login screen at step 805. In various examples, the logout option may not automatically log the driver out.

In some examples, at step 825, the driver application may offer a delete work order option. If the delete work order option is selected, the driver application 800 may delete the work order, update the database, and continue execution back to step 825.

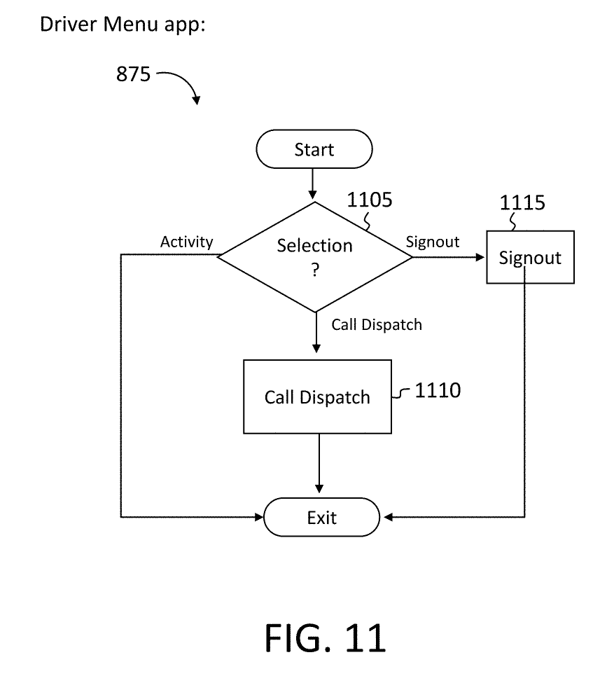

The driver application 800 includes a driver menu option 875. The driver may select the driver menu option 875. The driver menu option 875 is described in more detail with reference to FIG. 11.

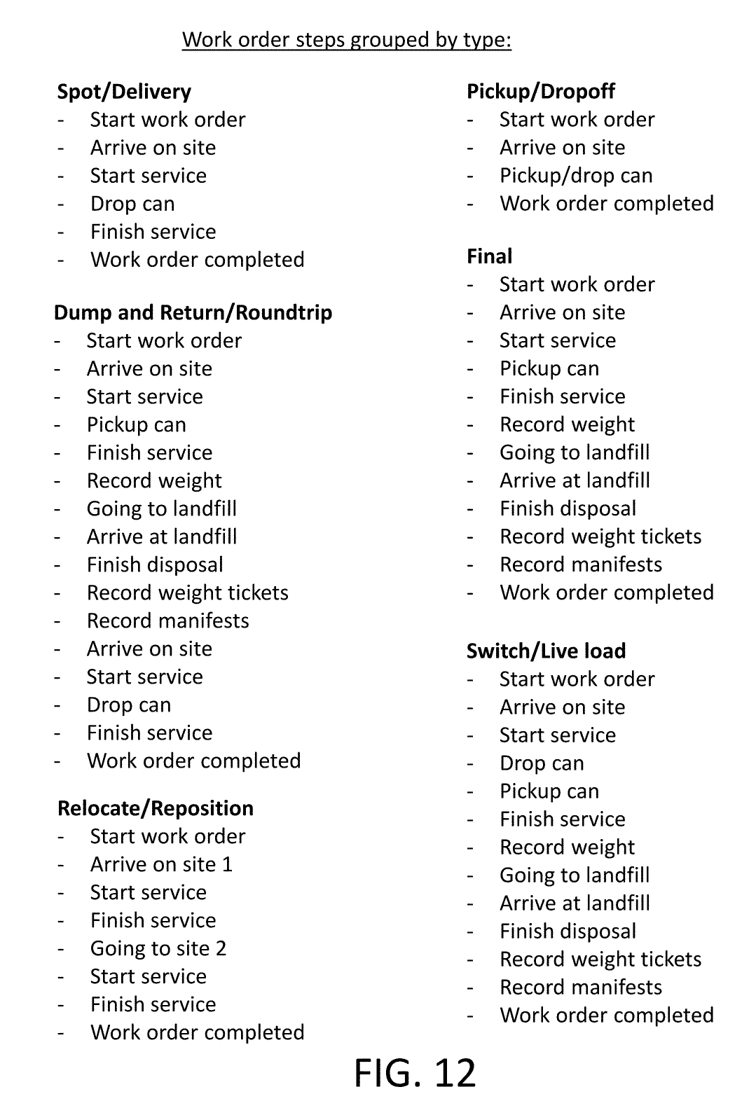

FIG. 9 depicts a flowchart of a work order steps submodule of an exemplary driver application. A work order steps submodule 830 may be employed by a driver. The steps populated in a work order steps module, such as work order steps module 830 may depend on the type of work order in process by the driver. Details of exemplary steps that may be included for various work orders are presented with reference to FIG. 12.

The work order steps submodule 830 begins execution at a step 905, where execution displays a map while waiting for the driver to make a step selection. If the driver selects arrive on site, then execution continues to step 910. At step 910, the work order steps submodule 830 displays a work order summary while waiting for the driver to make a next step selection. If the driver selects start service, then execution continues to step 915. At step 915, the work order steps submodule 830 displays a map and a form to enter a fixed asset number, while waiting for the driver to make a next step selection.

At step 915 the driver may enter a valid fixed asset identification number into the form presented by the work order steps submodule 830. Next, if the driver selects pick up fixed asset, then execution continues to step 920. At step 920, the work order steps submodule 830 validates the fixed asset identification number that was entered by the driver. If the fixed asset identification number is not valid (e.g., not an asset in the inventory database or not an asset at the site) then execution jumps back to step 915. Accordingly, the driver may not move to the next workflow step until a valid fixed asset identification number is entered. In this way, the system may provide an accurate and validated history of movable fixed asset pick-up and drop-off locations with timestamps, which may advantageously be provided to lending institutions to prove “chain-of-title” and/or “chain-of-custody” for a fleet of widely distributed movable fixed assets. Entry enforcement of the fixed asset identification number may also remove field (e.g., driver) discretion, effectively enforcing submission of fixed asset IDs and locations from drivers, for example. Drivers may experience reduced frustration as fixed assets may be in the expected locations.

In various implementations, the system may log the location of a fleet of movable fixed assets. The system may include an “unknown location” value for a location property, for example. The unknown location may keep the fixed asset within accounting visibility yet flag it with an unknown location. Since drivers are required to enter the fixed asset identification number of the fixed asset(s) on which they are performing services, the unknown locations may be replaced by actual locations at that time.

If the fixed asset identification number is valid (e.g., asset is in the inventory database and the asset is on the site) then execution continues to step 925. At step 925, the validated asset number may be updated in the database. Next, the work order steps submodule 830 continues to step 930. At step 930 the work order steps submodule 830 displays the work order summary while waiting for the driver to make a next step selection. If the driver selects finish service, then execution continues to step 935. At step 935, the work order steps submodule 830 displays an interactive weight form and the work order summary, while waiting for the driver to enter the weight information and to make a next step selection. If the driver selects record weight, then execution continues to step 940. At step 940, the work order steps submodule 830 updates the database with the weight information associated with the current work order, then continues to step 945. At step 945 the work order steps submodule 830 displays a map while waiting for the driver to make a next step selection. If the driver selects going to landfill, then execution continues to step 950. At step 950, the work order steps submodule 830 displays a map while waiting for the driver to make a next step selection. If the driver selects arrive at landfill, then execution continues to step 955. At step 955, the work order steps submodule 830 displays the work order summary while waiting for the driver to make a next step selection. If the driver selects finish disposal, then execution continues to step 960. At step 960, the work order steps submodule 830 displays the work order summary while waiting for the driver to make a next step selection. At step 960 the driver may select add record or may select record weight tickets.

If, at step 960, the driver selects add record, then execution continues to step 965. At step 965, the work order steps submodule 830 receives a digital photograph (e.g., weight ticket(s) and sends the photograph to the database. Execution then continues back to step 960.

If, at step 960, the driver selects record weight tickets, then execution continues to step 970. At step 970, the work order steps submodule 830 displays the work order summary while waiting for the driver to make a next step selection. At step 970 the driver may select add record or may select record.

If, at step 970, the driver selects add record, then execution continues to step 975. At step 975, the work order steps submodule 830 receives a digital photograph (e.g., photo image of manifest and sends the photograph to the database. Execution then continues back to step 970.

If, at step 970, the driver selects record manifest, then execution continues to step 980. At step 980, the work order steps submodule 830 displays the work order summary while waiting for the driver to make a next step selection. If, at step 980, the driver selects work order completed, then the work order steps submodule 830 is exited. As depicted in FIG. 9, in various steps, the driver has an option to “go back” to a previous step, as shown with the up arrows in the flowchart.

In various examples, the system may include tracking history. For example, for various steps a driver completes (e.g., clock in, add odometer, arrive on site, start service, pick up fixed asset, verify fixed asset identification number, finish service, record weight, going to landfill, arrive at landfill, finish disposal, record weight tickets, record manifest, work order completed, add work order, delete work order, call dispatch, add record (picture), add note, clock out) and/or for various steps a dispatcher completes (e.g., add work order, delete work order, receive payment, change work order) a database operation may be triggered, creating a tracking history within the database. The tracking history may advantageously provide an accurate record of the driver's and the dispatcher's activity. In various examples, the logging feature may provide a basis for various analytics on haulers, trucks, drivers and miles driven.

In various implementations, the work order screen may be a wizard that shows information relative to each step. The work order steps may be associated with a work order type. The work order type and/or steps may determine what shows on the work order page.

A driver may start a work order by clicking on the work order available in the list on an activity screen, then by selecting start work order. Selecting start work order may initiate the work order wizard. In some examples, the driver application may include a side panel. The side panel may aid a driver/user in navigation of the driver application.

Various selection options within the work order screens may call the API, which may perform a database update. Creating a pick-up fixed asset or a drop-off fixed asset work order may create a new work order to add to the list displayed on the activity screen.

FIG. 10 depicts a flowchart of an exemplary asynchronously selectable dispatch menu application. In the depicted example, the dispatch menu application 550 may be employed by a dispatcher selecting a menu icon. The dispatcher menu application 550 begins execution at a step 1005, where one or more general menu choices may be displayed. If the dispatcher selects reports, then execution continues to step 1010. At step 1010 one or more reports choices may be displayed. If the dispatcher selects haul reports, execution continues to step 1015. If the dispatcher selects aging reports, execution continues to step 1020. Accordingly, future report types may be included. If a future report type is selected, then execution continues to step 1025.

At step 1015 the haul report is collated and formatted. At step 1020 the aging haul report is collated and formatted. Accordingly, at step 1025 a report of some future implementation may be collated and formatted. Execution continues to step 1030, where the report is sent to a printer, and the dispatch menu application 550 is exited.

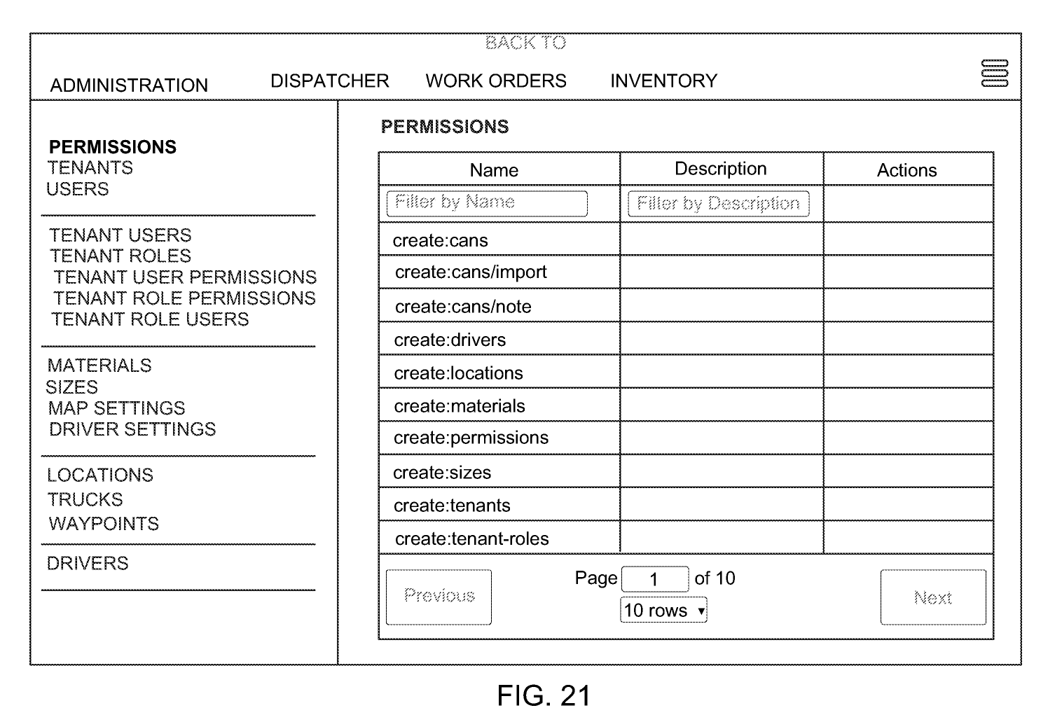

If, at step 1005, the dispatcher selects administration, then execution continues to step 1035. At step 1035 an administration screen is displayed. By way of example and not limitation, a variety of administration options are depicted in FIGS. 21-29. Each of the options may be selected by the dispatcher to perform the various administrative duties. In the depicted examples, the administrative options form an administration palette, which may remain displayed in a column on the left edge of the administration screen. For example, the administration palette may include management of permissions and/or roles, of tenants, users and tenant users. In some examples, the administration palette may include management of materials, sizes, locations, trucks, waypoints and/or drivers. In various examples, the administrative palette may include options to manage driver settings and/or map settings. If the dispatcher selects inventory, dispatch or work orders the dispatch menu application 550 is exited.

If, at step 1005 dispatcher selects logout, then execution continues to step 1040. At step 1040 the dispatch menu application 550 logs the dispatcher out of the top-level application.

FIG. 11 depicts a flowchart of an exemplary asynchronously selectable driver menu. In the depicted example, the driver menu application 875 may be employed by a driver selecting a menu icon. The driver menu application 875 begins execution at a step 1105, where one or more general menu choices may be displayed. If the driver selects activity, then the driver menu application 875 is exited. If the driver selects call dispatch, then execution continues to step 1110, where the driver menu application 875 makes a system call to the telephone module within the mobile device to place a telephone call to a dispatcher. If the driver selects sign-out, then execution continues to step 1115. At step 1115 the driver menu application 875 logs the driver out of the top-level application.

FIG. 12 depicts an exemplary listing of work order steps associated with work order types. The work order steps submodule (FIG. 9, item 900) includes multiple exemplary steps (905-915, 930-960, 970 and 980) according a specific exemplary type of work order being executed. In various examples, a dispatcher may assign to a driver, work orders of one or more types, each work order including an associated set of steps. By way of example and not limitation, FIG. 12 presents exemplary steps associated with exemplary work order types. Accordingly, the steps in FIG. 12 may be substituted for the steps in FIG. 9.

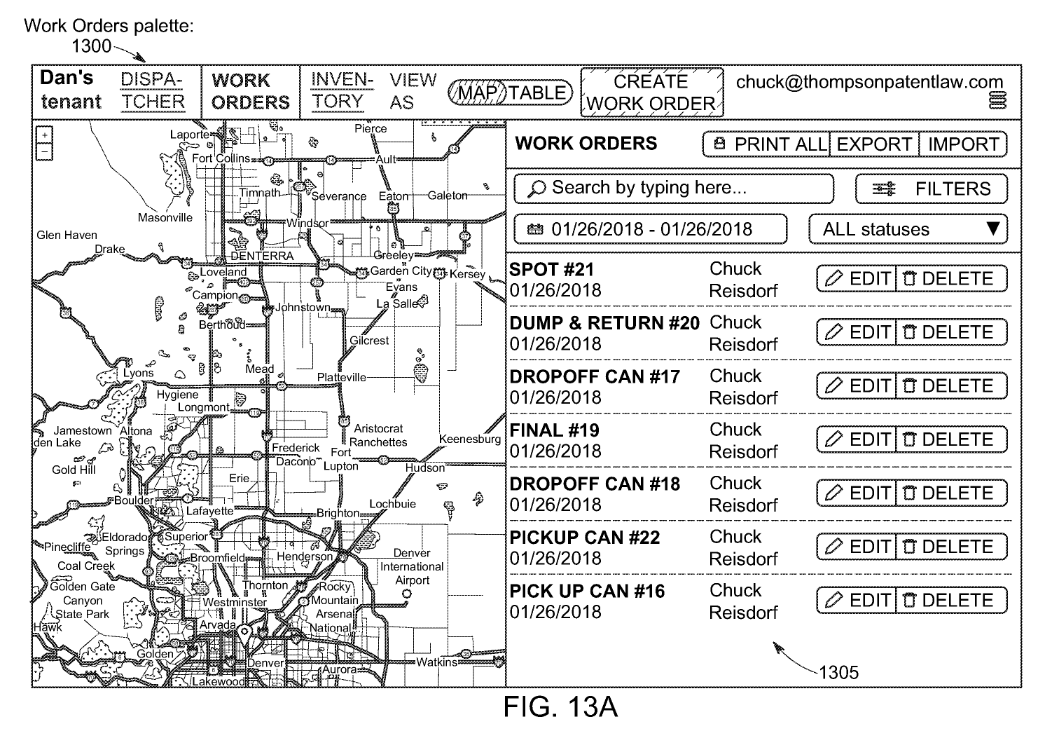

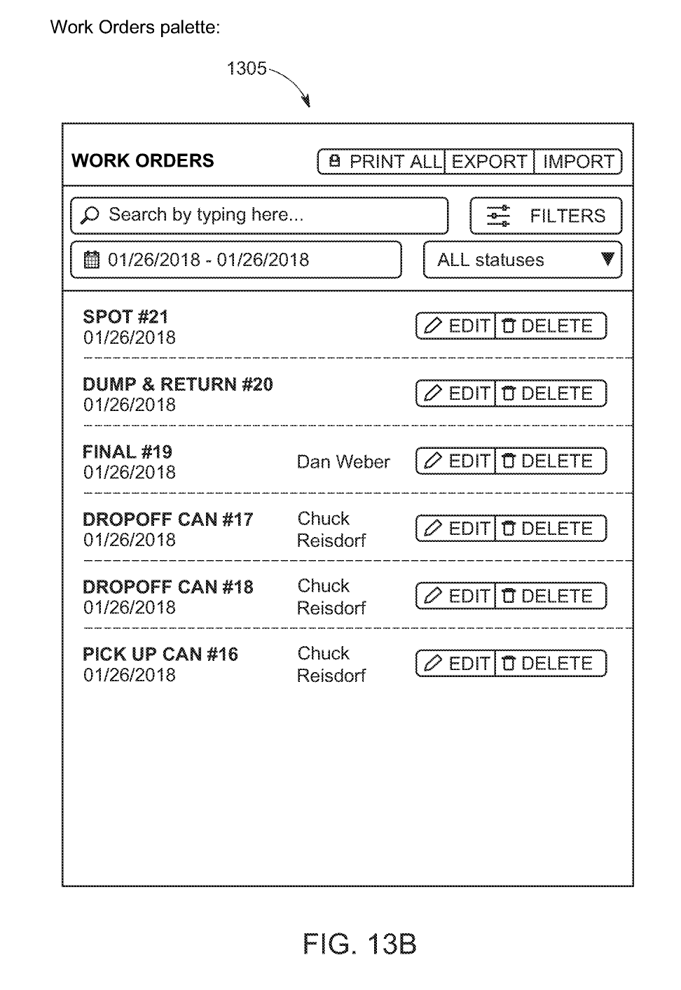

FIGS. 13A and 13B depict an exemplary work order palette. As described with reference to FIG. 5, the work order application 500 includes a work order screen as described in step 505. FIG. 13A depicts an exemplary work order screen 1300. The work order screen includes a work order palette 1305. The work order palette is shown in greater detail in FIG. 13B.

FIG. 14A depicts an exemplary workflow palette. As described with reference to FIG. 6, the dispatch application 600 includes a dispatch screen as described in step 605. FIG. 14A depicts an exemplary dispatch screen 1400. The dispatch screen 1400 includes a workflow palette 1405. Assigned work orders for the selected drivers are shown on the workflow palette 1405. Additional work orders may be assigned to the selected driver's workflow by dragging the work orders from the map section of the dispatch screen 1400 to the workflow palette 1405.

FIG. 14B depicts an exemplary driver palette. The dispatch screen (FIG. 14A, item 1400) includes a driver palette 1410. A dispatcher may pre-select a driver from the driver palette 1410, then expand the work orders for that driver in a workflow palette (FIG. 14A, item 1405).

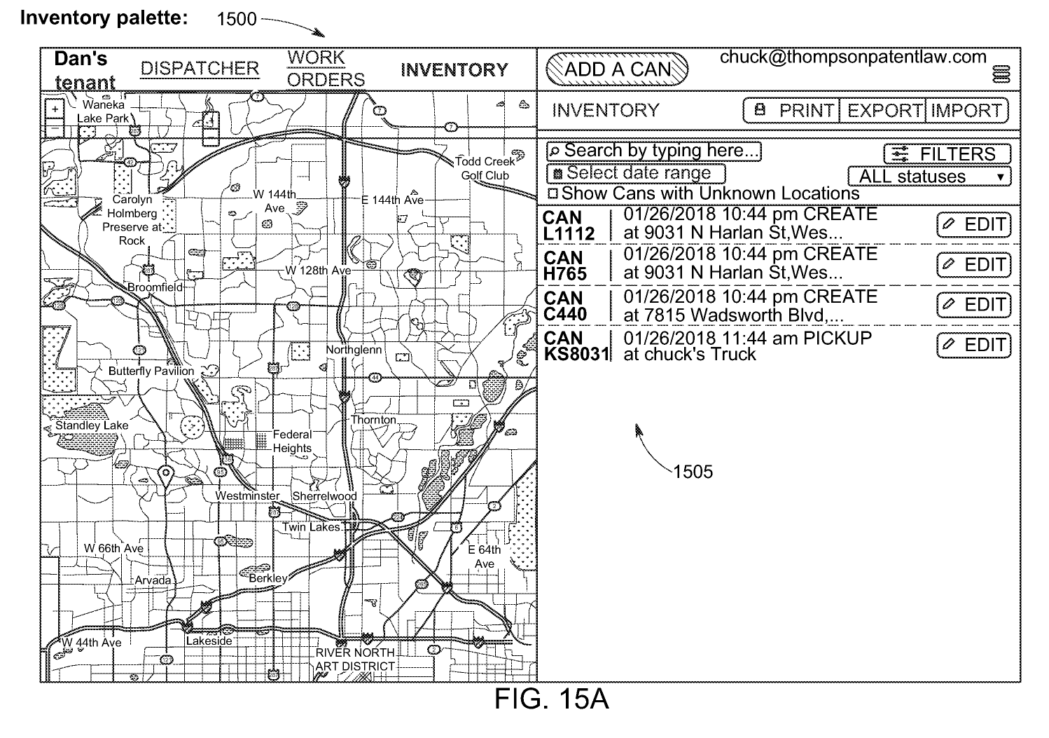

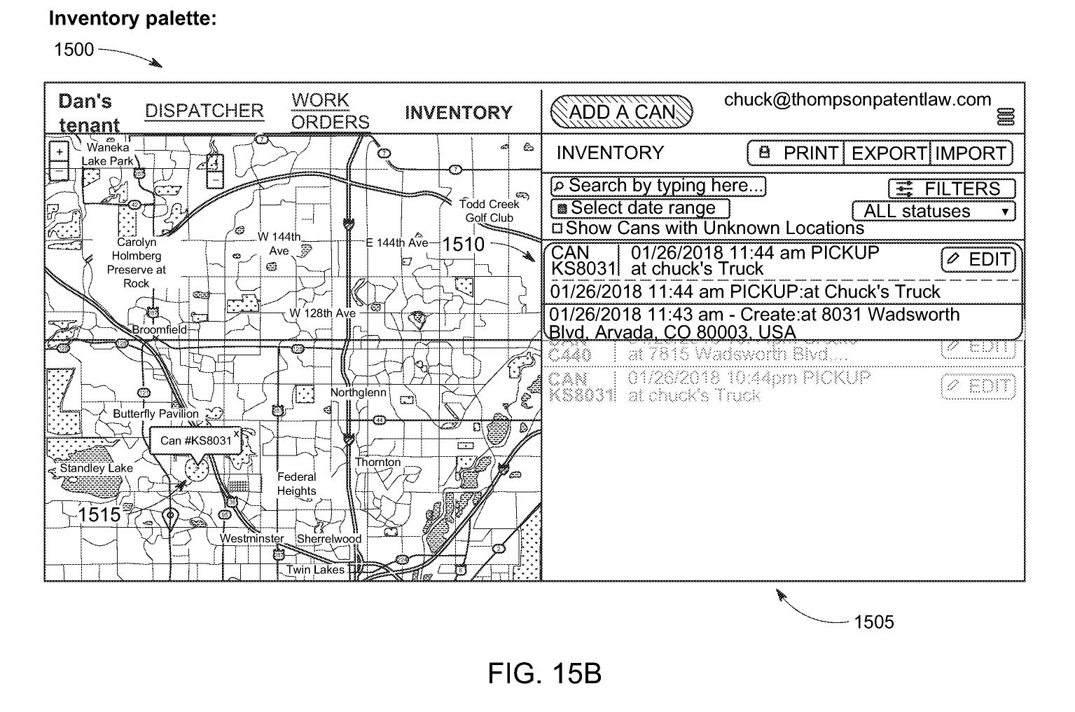

FIGS. 15A and 15B depicts an exemplary inventory palette. As described with reference to FIG. 7, the inventory application 700 includes an inventory screen as described in step 705. FIG. 15 depicts an exemplary inventory screen 1500. The inventory screen 1500 includes an inventory palette 1505. In FIG. 15B a dispatcher has selected a listed fixed asset 1510 on the inventory palette 1505. The listed fixed asset 1510 is associated with a mapped fixed asset 1515 located on the map portion of the inventory screen 1500. A dispatcher may select a listed fixed asset, such as listed fixed asset 1510, and find an associated location when the inventory application 700 highlights an associated mapped fixed asset, such as mapped fixed asset 1515. Accordingly, in some examples, a listed fixed asset may be highlighted by the inventory application 700 in response to a dispatch-selected mapped fixed asset.

FIGS. 16A and 16B depict various design aspects of an exemplary work order puzzle piece. A work order puzzle piece 1600 includes a first fixed asset size dimple 1605, a second fixed asset size dimple 1610, and a third fixed asset size dimple 1615. Each of the dimples 1605, 1610, and 1615 are located in a unique fixed position on the work order puzzle piece 1600. The work order puzzle piece 1600 includes a first fixed asset size bump 1620, a second fixed asset size bump 1625, and a third fixed asset size bump 1630. Each of the bumps 1620, 1625, and 1630 are located in a unique fixed position on the work order puzzle piece 1600. Each of the unique positions of both the dimples 1605, 1610, 1615 and the bumps 1620, 1625, and 1630 may represent a unique fixed asset size. For example, the first fixed asset size dimple 1605 and the first fixed asset size bump 1620 may represent a first fixed asset size. The second fixed asset size dimple 1610 and the second fixed asset size bump 1625 may represent a second fixed asset size. The third fixed asset size dimple 1615 and the third fixed asset size bump 1630 may represent a third fixed asset size. Accordingly, additional bumps and dimples may be added to unique positions on the work order puzzle piece proving additional fixed asset sizes to the system. The bumps and dimples in FIG. 16A are presented by way of example and not limitation. For example, the bumps and dimples may be shaped as spherical, triangular, rectangular, or irregular. The bumps and dimples may be placed on various edges of the work order puzzle piece. In some examples, combinations of bumps and dimples may encode a unique fixed asset size.

The work order puzzle pieces may be configured such that the top edge represents a fixed asset size required to start a work order. The work order puzzle pieces may be configured such that the bottom edge represents a fixed asset size available at the completion of a work order. The roles the bumps and dimples play may be reversed, in some examples. For a given edge of the puzzle pieces, the bumps and dimples may be used alone or in combination.

In some examples, the size of the fixed asset required at the beginning of a work order may be represented on the top edge of the puzzle piece or the bottom edge of the puzzle piece. By way of example and not limitation, the unique fixed asset sizes may be represented by a unique surface on the puzzle piece, for example, a jagged edge, a smooth wave, or a unique arbitrary shape. Accordingly, the size of the fixed asset available at the completion of a work order may be represented on the bottom edge of the puzzle piece or the top edge of the puzzle piece. By way of example and not limitation, the unique fixed asset sizes may be represented by a unique surface on the puzzle piece, for example, a jagged edge, a smooth wave, or a unique arbitrary shape. In various examples, the puzzle piece sides may represent the beginning and completion of a work order. The puzzle pieces may have a generally rectangular shape, ovular shape, trapezoidal shape, octagonal shape, or pill shape, for example. In various implementations, the puzzle pieces may mate on edges having like colors.

One or more work order puzzle pieces 1600 may be arranged on a work order palette as describe with reference to FIG. 14, item 1405. The work order puzzle pieces 1600 may be configured to interlock only when the size of an available fixed asset, at the completion of a given work order is compatible with the size of a required fixed asset, at the start of an immediately succeeding work order. A dispatcher may create a workflow with the work orders via the work order puzzle pieces. The dispatcher may be advantageously visually aided by the shapes of the work order interlocking features (e.g., the bumps and the dimples). Various design implementation examples are depicted in FIG. 16B.

In a first illustrative example, a pick-up can work order 1635 interlocks with a drop off can work order 1640. The pick-up can work order 1635 includes a bump 1635B. The drop off can work order 1640 includes a dimple 1640D. Since the 10-yard fixed asset size (e.g., can size) at the completion of the pick-up can work order 1635 is compatible with the 10-yard fixed asset size required at the start the drop off can work order 1640, the work order 1635 and 1640 puzzle pieces fit together via bump 1635B and dimple 1640D. In this example, the completion of the pick-up can work order 1635 includes the 10-yard fixed asset on the back of the driver's truck. The pick-up work order 1635 includes a bump in the first position at the bottom edge of the work order puzzle piece in response to the 10-yard fixed asset on the truck at the completion of the work order. The first position is associated with the 10-yard fixed asset, and the bottom edge is associated with the completion of the work order. Further, the start of the drop-off fixed asset work order 1640 requires a 10-yard fixed asset. The drop off fixed asset work order 1640 includes a dimple in the first position at the top edge of the work order puzzle piece in response to the 10-yard fixed asset requirement at the start of the work order 1640. The first position is associated with the 10-yard fixed asset, and the top edge is associated with the beginning of the work order.

In a second illustrative example, a final work order 1645 interlocks with a drop off can work order 1650. Since the 12-yard fixed asset size (e.g., can size) at the completion of the final work order 1645 is compatible with the 12-yard fixed asset size required at the start the drop-off can work order 1650, the work order puzzle pieces 1645 and 1650 fit together. In this example, the completion of the final work order 1645 includes the 12-yard fixed asset on the back of the driver's truck. The final work order 1645 includes a bump in the second position at the bottom edge of the work order puzzle piece in response to the 12-yard fixed asset on the truck at the completion of the work order. The second position is associated with the 12-yard fixed asset, and the bottom edge is associated with the completion of the work order. Further, the start of the drop-off fixed asset work order 1640 requires a 12-yard fixed asset. The drop-off fixed asset work order 1640 includes a dimple in the second position at the top edge of the work order puzzle piece in response to the 12-yard fixed asset requirement at the start of the work order 1640. The second position is associated with the 12-yard fixed asset, and the top edge is associated with the beginning of the work order.

A dump and return work order 1655 follows the drop off can (e.g., fixed asset) work order 1650. Since the drop off can work order 1650 leaves the back of the driver's truck empty, the bottom of the work order puzzle piece 1650 is flat. Since the dump and return work order 1655 requires an empty truck, the top of the work order is flat. Since these work orders are compatible in that sequence, the puzzle pieces fit together.

In the depicted example of FIG. 16A, a spot work order 1660 follows the dump and return work order 1655. Since the two work orders 1655 and 1660 are not compatible, since the dump and return work order 1655 does not complete with a fixed asset on the driver's truck, and the spot work order 1660 needs a fixed asset. Since the work order 1655 and 1660 are not compatible, they are shown with a separation 1665.

In various examples, work order puzzle pieces may be colored to indicate various types, for example. The various types may be, for example, those listed in FIG. 12.

FIG. 16C depicts an exemplary work order form. A dispatcher may complete various portions of the form and select save. Once saved the database is updated with the new work order.

FIG. 16D depicts an exemplary work order form. A dispatcher may complete various portions of the form and select save. Once saved the database is updated with the new fixed asset.

FIGS. 16E, 16F and 16G depict exemplary edit fixed asset forms. A dispatcher may edit various properties as shown, for example in FIGS. 16E, 16F and 16G.

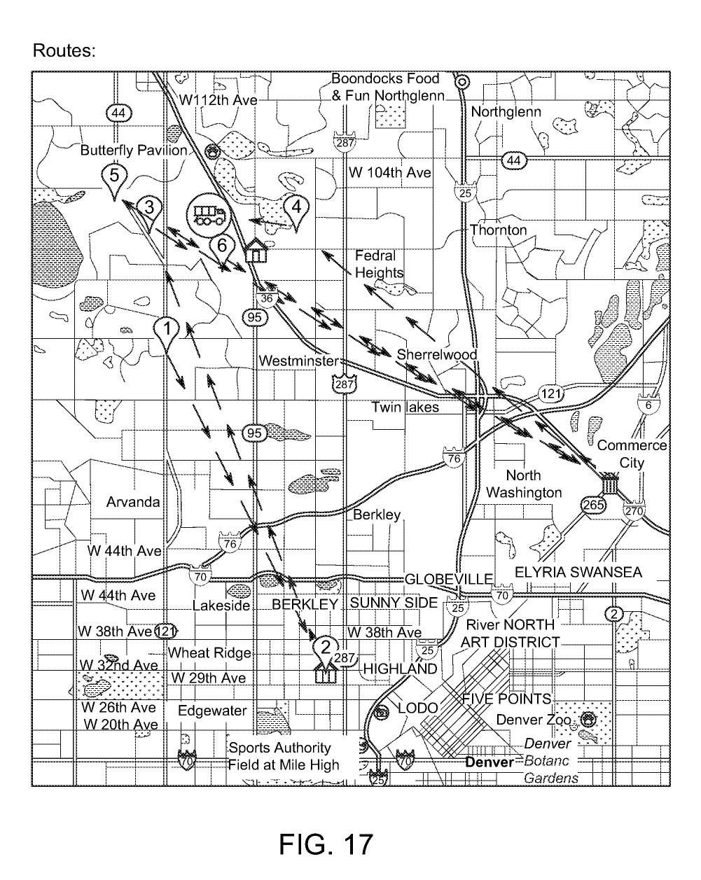

FIG. 17 depicts an illustrative route mapping generated by an exemplary dispatch application. In the depicted example, the locations of the work orders are connected by arrows in the order they are assembled on a workflow palette. The arrows in the route mapping may advantageous provide a visual aid to a dispatcher assembling a driver's workflow. For example, the dispatcher may see visually that certain work orders are out-of-the-way for a driver. The dispatcher may move the puzzle pieces on the workflow palette to create a more economical network of routes, for example. The routes may provide a visual logistics map.

FIGS. 18A, 18B, 18C, 18D, 18E, 18F and 18G depict illustrative driver application screens generated by an exemplary driver application. In FIG. 1A, a driver application screen running on a driver's mobile device includes a pre-trip screen. The pre-trip screen receives a selectable check box for clocking in, and for entry of an odometer reading for the driver's truck. The driver may not be permitted to move on to the next step until a valid odometer reading is entered. Once the odometer reading is entered, the driver may view the work orders assigned to his workflow.

In FIG. 18B the driver has expanded a work order by selecting it. In the depicted expanded work order example, the driver may have the option to show a map of the work order, add notes to be associated with the work order, to start the work order, or to delete the work order.

As depicted in FIG. 18C, a driver application screen presents an exemplary work order on a driver's mobile device. The driver may select start work order, for example, and progress to the exemplary screen depicted in FIG. 18D. In FIG. 18D, the driver application displays a map of the work order location. When arriving on site, the driver may select arrive on site (at the bottom of the screen). Accordingly, the driver may step through the prescribed steps displayed on the driver application. In the exemplary step depicted in FIG. 18E, the driver may be required to enter a fixed asset identification number (can number). The driver may proceed to the next step only when a valid fixed asset identification number is entered in the field, for example. In the exemplary step depicted in FIG. 18F, a valid fixed asset identification number of “L1112”, for example, is entered by the driver. The driver may then select pickup can (at the bottom of screen) to go to the next work order step. In the exemplary step depicted in FIG. 18G, a valid weight of “3” (Tons), for example, is entered by the driver. In some embodiments, the driver may select the next step only when a valid weight is entered. The driver may then select record weight (at the bottom of screen) to go to the next work order step. The steps described are exemplary only.

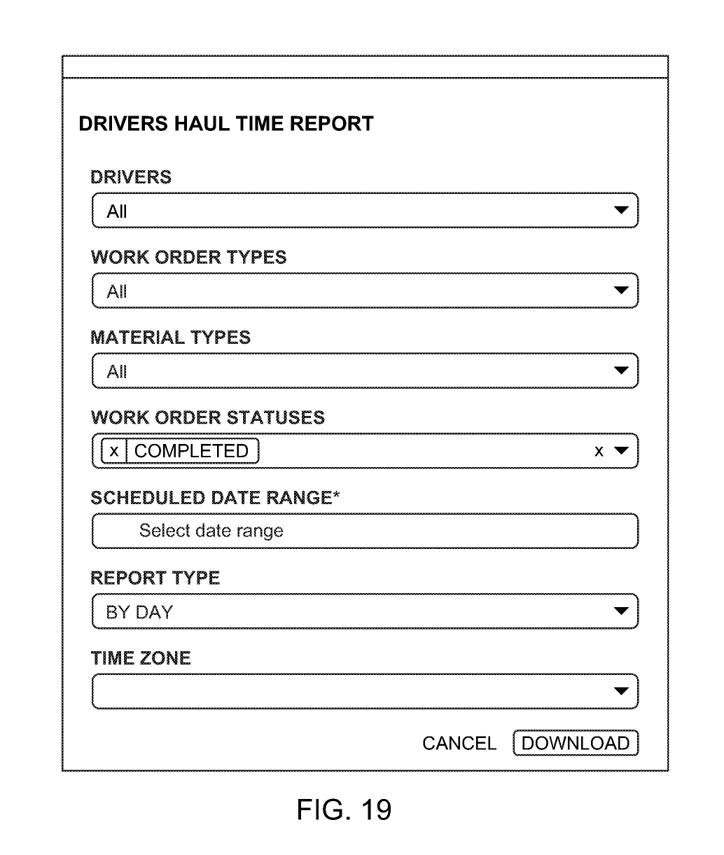

FIG. 19 depicts an exemplary context window for a driver's haul time report.

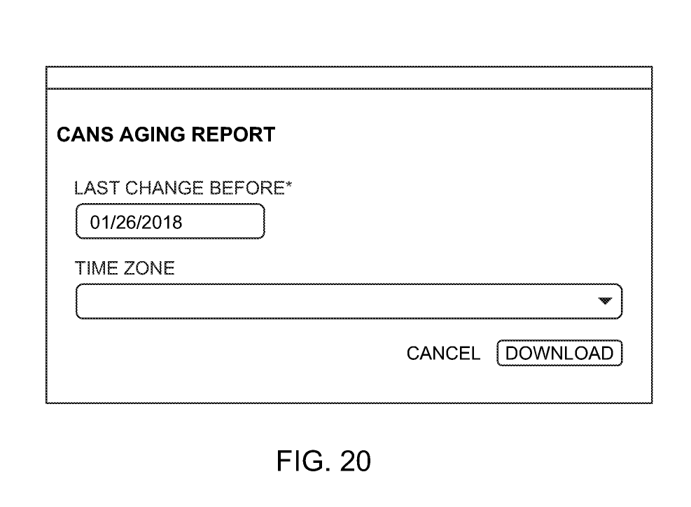

FIG. 20 depicts an exemplary context window for a fixed asset aging report.

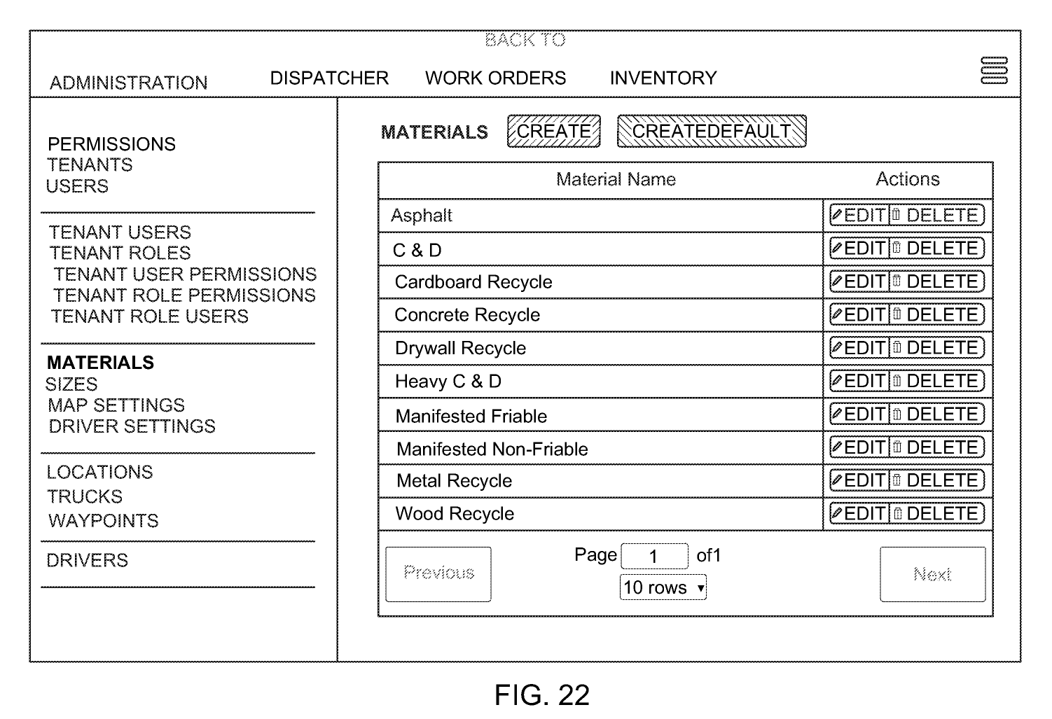

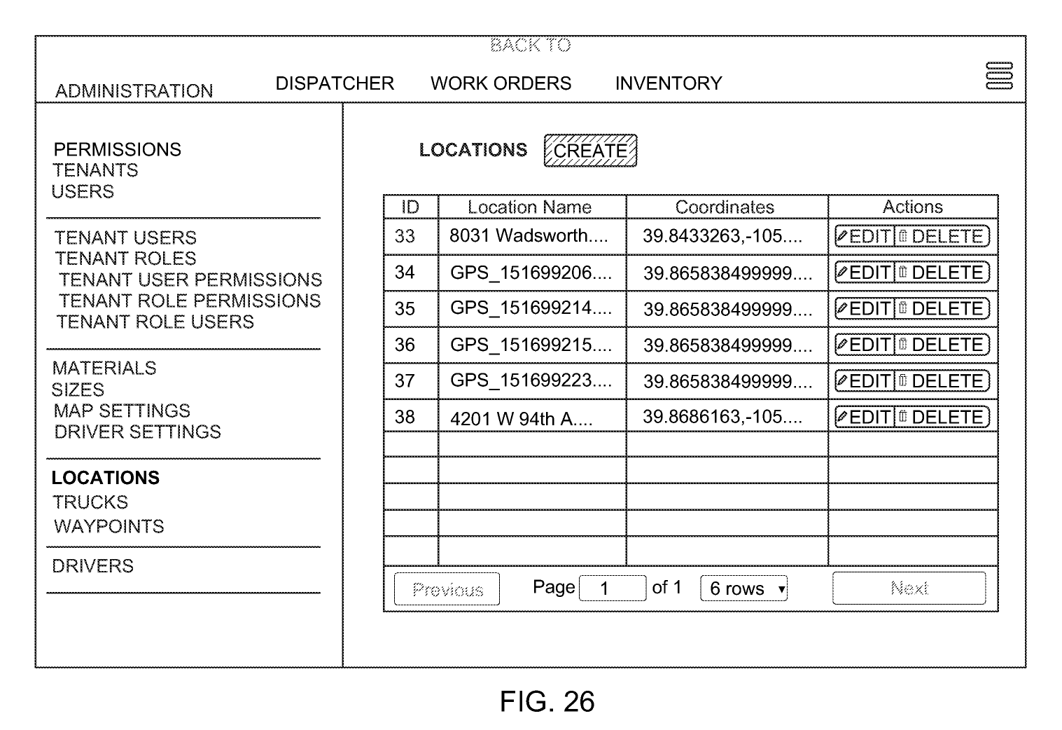

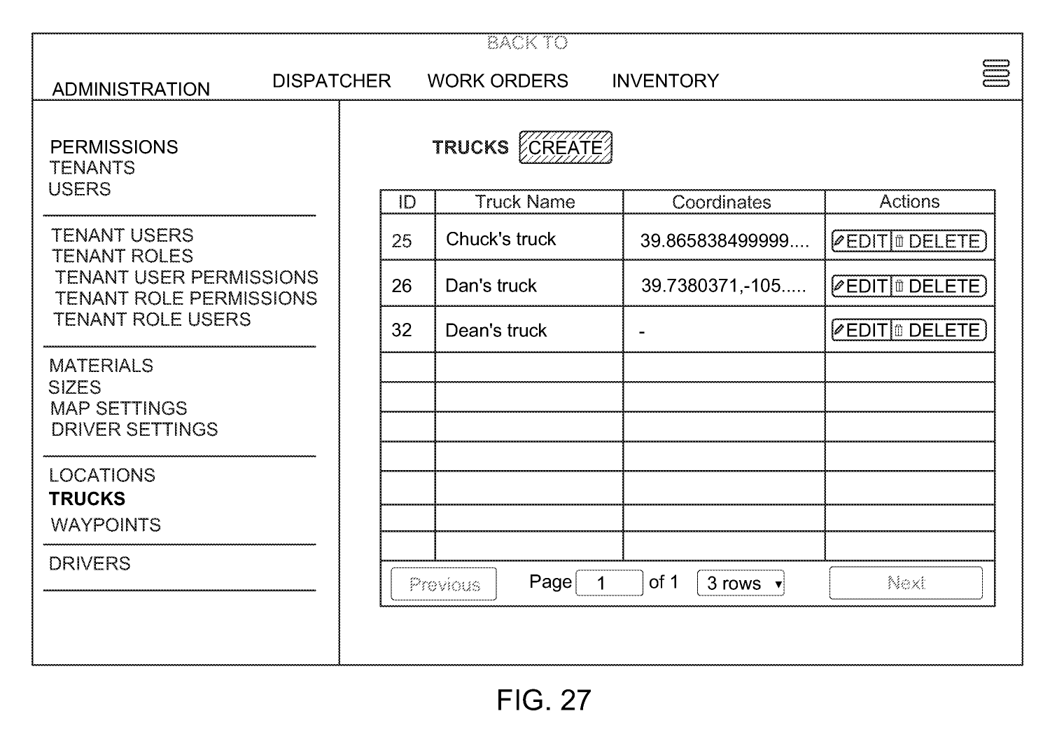

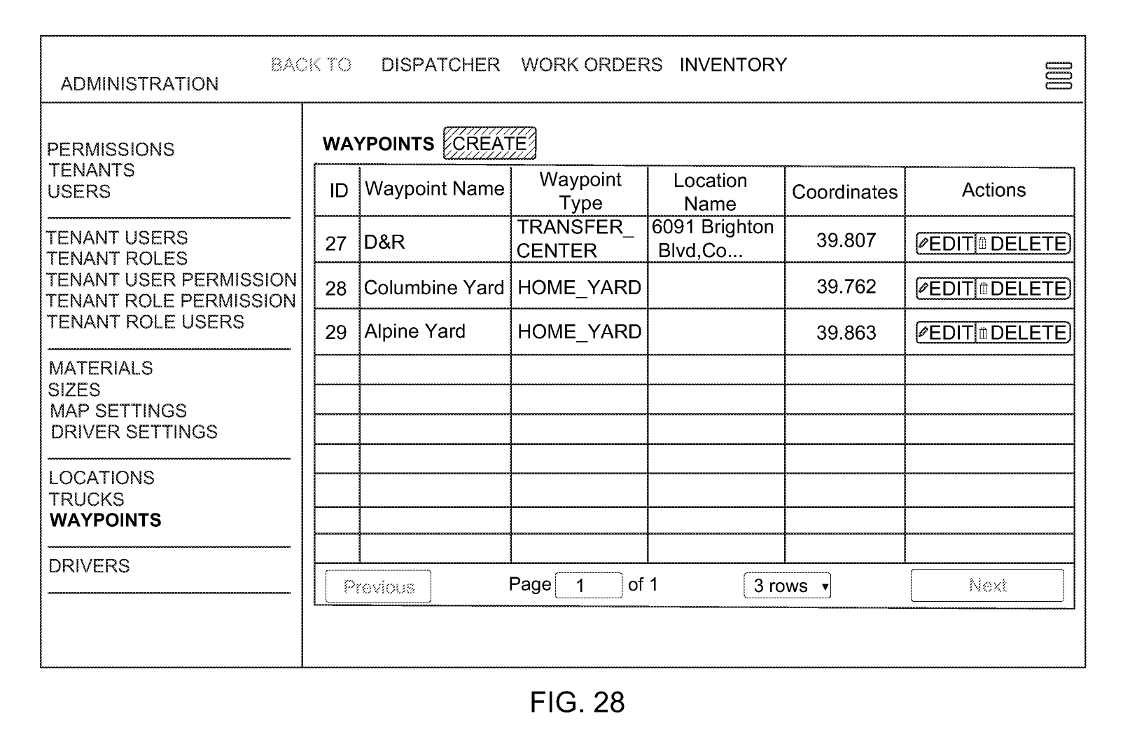

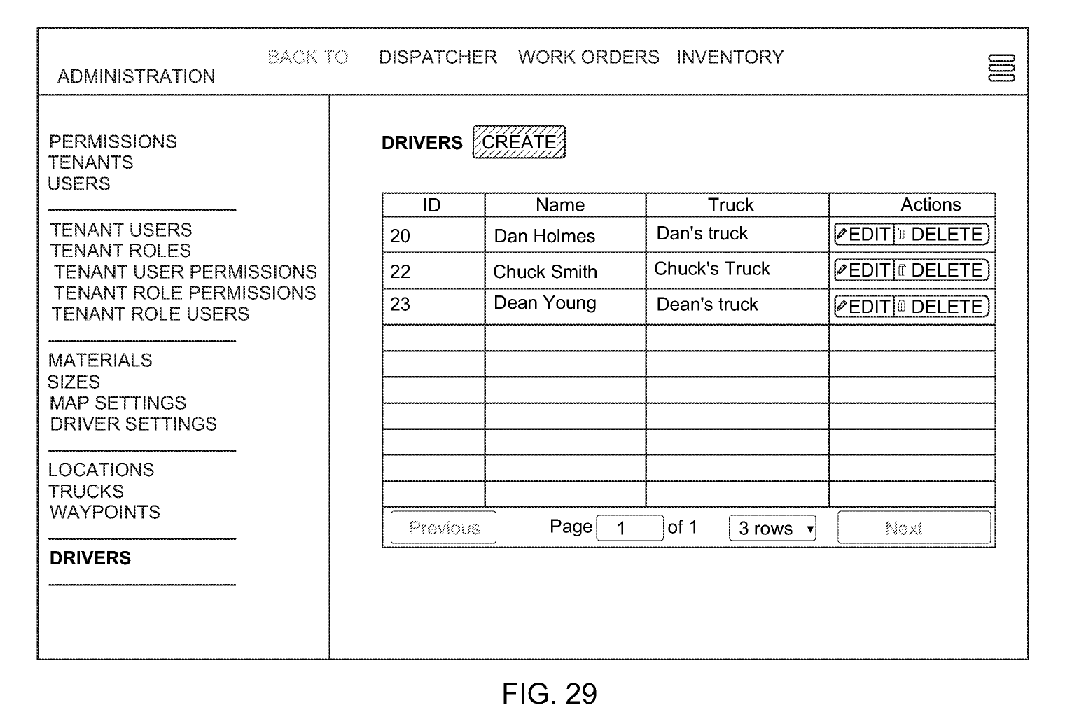

FIGS. 21, 22, 23, 24, 25, 26, 27, 28 and 29 depict exemplary administration screens. FIG. 21 depicts an exemplary screen in which a dispatcher/administrator may set user and/or tenant permissions. FIG. 22 depicts an exemplary screen in which a dispatcher/administrator may add various material selection options to the system. The various materials may become items on a material pull-down list within the materials field of a work order creation form. FIG. 23 depicts an exemplary screen in which a dispatcher/administrator may add various size selection options to the system. The various sizes may become items on a size pull-down list within the size field of a work order creation form. FIG. 24 depicts an exemplary screen in which a dispatcher/administrator may adjust various map settings. The various map settings may be used to display maps, for example, on a work order creation form. FIG. 25 depicts an exemplary screen in which a dispatcher/administrator may adjust and/or add various driver settings. Various driver settings may include, for example, the dispatcher number for that driver, the driver's mobile phone number, the driver's preferred name, and/or the driver's preferred work hours. FIG. 26 depicts an exemplary screen in which a dispatcher/administrator may add various location selection options to the system. The various locations may become items on a location pull-down list within the location field of a work order creation form. FIG. 27 depicts an exemplary screen in which a dispatcher/administrator may add various truck selection options to the system. The various trucks may become items on a truck pull-down list within the truck field of a work order creation form. FIG. 28 depicts an exemplary screen in which a dispatcher/administrator may add various waypoint selection options to the system. The various waypoints may become items on a location pull-down list within the location field of a work order creation form. FIG. 29 depicts an exemplary screen in which a dispatcher/administrator may add various driver selection options to the system. The various drivers may become items on a driver pull-down list within the driver field of a work order creation form.

Although various embodiments have been described with reference to the figures, other embodiments are possible. For example, the system may include tracking history. For example, for various steps a driver completes (e.g., clock in, add odometer, arrive on site, start service, pick up fixed asset, verify fixed asset identification number, finish service, record weight, going to landfill, arrive at landfill, finish disposal, record weight tickets, record manifest, work order completed, add work order, delete work order, call dispatch, add record (picture), add note, clock out) and/or for various steps a dispatcher completes (e.g., add work order, delete work order, receive payment, change work order) a tracking history may be recorded within the database. The tracking history may advantageously provide an accurate record of the driver's and the dispatcher's activity. In various examples, the logging feature may provide a basis for various analytics on haulers, trucks, drivers and miles driven.

In various implementations, the system may log the location of a fleet of movable fixed assets. The management of the log may be implemented on a virtual double-entry ledger. The virtual double entry ledger may advantageously account for a company's movable fixed assets. In some examples, the system may include an “unknown location” value for a location property. The unknown location may keep the fixed asset within accounting visibility yet flag it with an unknown location. Since drivers are required to enter the fixed asset identification number of the fixed asset(s) on which they are performing services, the unknown locations may be replaced by actual locations at that time.

In some embodiments, the system may provide a collaboration of work orders between dispatchers and drivers. Such a collaboration may provide full coverage of work by using the work orders. For example, if a dispatcher assigns a work order to a driver that requires a fixed asset, but the previous work order does not leave a fixed asset, the driver may create a work order to go to a retention location to pick up a fixed asset. In some examples, the drivers may be restricted to perform services only when they appear on a work order. This restriction may, in some embodiments, advantageously create a system that covers all or substantially all driver activities in the field.

In some examples, the dispatcher and drivers may receive notifications when a work order is changed. Accordingly, the driver and dispatcher may visually verify that the work order changes are reflected in the driver's workflow.

In various implementations, address locations in various location fields may automatically suggest locations as the user types. The automatic location suggestion may save time for users of the system. In some examples, work orders may be transferred to different locations within a driver's workflow. In some implementations, work orders may be transferred between drivers. These transfers may be performed by users by employment of drag-and-drop functionality.

Various examples may employ a manual over-ride. For example, a dispatcher may change the identification number of fixed asset within the database. Various embodiments may employ a bulk-order feature. The bulk-order feature may advantageously add one or more work orders at one time. Various embodiments may implement a bulk-add feature. The bulk-add feature may add one or more assets to the system inventory at one time. Some embodiments may auto-sequence the asset identification numbers.

In various implementations, the add record feature discussed with reference to FIG. 9 may advantageously provide a substantially high-resolution image of the contents within a fixed asset. The add record may record an image of the weight tickets, for example.

Leadership in Energy and Environmental Design (LEED) may be a popular ecological building certification program. In examples of LEED disposal, images of the contents within a fixed asset (e.g., a roll-off waste container) may be used as evidence in various disputes.

In various embodiments, the dispatcher may reassign a work order in progress to a new driver. In some examples, a driver may reassign an owned work order to a new driver. Various examples of the fixed asset management system may not be limited to fixed assets. By way of example and not limitation, some embodiments may manage delivery of restaurant food, delivery of non-food items, transportation of passengers, dispatching of service vehicles, and/or dispatching of emergency vehicles.

In some implementations, the system may manage a fortified double-entry bookkeeping system. The system may create a virtual bank account for every jobsite, every yard, every truck, every landfill, and every unspecified (e.g., unknown) location that is created on the system. A host application may work with a driver app, which may move to the next workflow step after validation of an acceptable size, an acceptable location, and an acceptable work order type. Movable fixed assets must also be registered at the proper location in order to move to the next step. The scheme creates a feedback mechanism that forces drivers to update inventory. This is an incremental cycle counting system that works at point-of-use. Every time a driver picks up a movable fixed asset or drops off a moveable fixed asset the cycle-count within the system is updated and verified. In various implementations, the system keeps a continuous history of movable fixed assets, with global positioning system (GPS) latitudes, GPS longitudes and timestamps. The entry of fixed asset identification may be facilitated through scanning of a machine-readable code (e.g., barcode, quality (Q) code) or radio frequency (RF) tag (e.g., radio frequency identification (RFID), near-field communication (NFC)). This scheme may advantageously provide a substantially accurate inventory system for movable fixed assets.

Some embodiments may include an unknown location property. If the unknown location property is true, then the fixed asset may be bootstrapped into the system when it is first picked-up. The first location could be a truck since trucks may include a known location.

In various examples, the system may include a heuristic model to disambiguate two or more fixed assets with the same identifier in the same location. Further, the system may provide a pin location on a map that may be electronically dragged and may automatically mitigate duplicate locations with the same identifier. In some implementations, the fixed assets may be associated with a “name of location” as well as an address. This scheme may allow the system to index the fixed asset by street address as well as by GPS coordinates, for billing purposes, for example. The GPS coordinates may provide a higher resolution of the fixed asset location.

In some implementations, the system may be implemented with a peer-to-peer database. The peer-to-peer database may allow replication. Replication of the database may provide faster access and may provide a higher data integrity as the database is distributed.

The system may include a “beginning inventory” and “ending inventory” and pending transactions. This inclusion may mitigate over-selling of fixed assets.

Some aspects of embodiments may be implemented as a computer system. For example, various implementations may include digital and/or analog circuitry, computer hardware, firmware, software, or combinations thereof. Apparatus elements can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Some embodiments may be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example and not limitation, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits). In some embodiments, the processor and the member can be supplemented by, or incorporated in hardware programmable devices, such as FPGAs, for example.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. An exemplary embodiment may be implemented in a computer system that includes a graphical user interface and/or an Internet browser. To provide for interaction with a user, some implementations may be implemented on a computer having a display device, such as an LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from a source to a first receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, FireWire, ATA/IDE, RS-232, RS-422, RS-485, 802.11 a/b/g/n, Wi-Fi, WiFi-Direct, Li-Fi, BlueTooth, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

In various embodiments, a computer system may include non-transitory memory. The memory may be connected to the one or more processors may be configured for encoding data and computer readable instructions, including processor executable program instructions. The data and computer readable instructions may be accessible to the one or more processors. The processor executable program instructions, when executed by the one or more processors, may cause the one or more processors to perform various operations.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are within the scope of the following claims.

What is claimed is:

1. An apparatus comprising:
a processor;
a non-transitory computer readable medium operably coupled to the processor and containing a program of instructions that, when executed by the processor, cause the processor to perform operations comprising:
receiving a unique asset identification number and a current asset location-disposition from a driver-user;
validating the received information with an expected result; and,
send a next work-flow instruction to the driver-user only if the unique asset identification number and the asset location-disposition are valid.
